(19) United States
(12) Patent Application Publication
(10) Pub. No.: US 2017/0054148 A1
(43) Pub. Date: Feb. 23, 2017

(54) COMPOSITES COMPRISING HALLOYSITE TUBES AND METHODS FOR THEIR PREPARATION AND USE

(71) Applicant: XI'AN JIAOTONG UNIVERSITY, Xi'an, Shanxi (CN)

(72) Inventors: Shujiang DING, Xi'an, Shanxi (CN); Jin LIANG, Xi'an, Shanxi (CN)

(73) Assignee: XI'AN JIAOTONG UNIVERSITY, Xi'an, Shanxi (CN)

(21) Appl. No.: 15/308,018

(22) PCT Filed: Apr. 30, 2014
(86) PCT No.: PCT/CN2014/076577

§ 371 Date: Oct. 31, 2016

(51) Int. Cl. H01M 4/36; H01M 4/62; H01G 11/46; H01M 4/52; H01G 11/32; H01G 11/38; C09C 1/42; H01M 10/0525

(52) U.S. Cl. CPC H01M 4/366; C09C 1/42; H01M 4/625; H01M 4/623; H01M 10/0525; H01M 4/52; H01G 11/32; H01G 11/38; H01G 11/46; C01P 2006/40; C01P 2004/03; C01P 2004/04; C01P 2002/88; C01P 2002/72; C01P 2002/85

(57) ABSTRACT

Composite materials that include halloysite tubes, and methods for their preparation and use are disclosed. The composite material includes an amount of halloysite tubes having one or more oxides, one or more hydroxides, or both, on at least a surface of the halloysite tubes. The composite material can be incorporated into electrodes and electrochemical storage devices.

### BACKGROUND

Growing demands for environmental protection and for energy-intensive applications have stimulated research interests in energy storage and alternative energy sources. One of the more ideal candidates for green energy storage devices are supercapacitors, which have been widely studied due to their long and stable cycle life, short charging time, high power density, low maintenance cost and minimal safety concerns. These electrochemical properties make supercapacitors suitable for momentary energy smoothing load services such as emergency power supplies and peak power assistance for batteries in electric vehicles. However, practical applications of supercapacitors have been hampered by the inherent drawbacks of the existing electrode materials, such as the high cost of the RuO₂ based materials, relatively low specific capacitance of the carbon based materials and the poor cycling stability of pseudocapacitive materials.

### SUMMARY

The present disclosure relates to a method of preparing a composite. The method includes contacting an amount of halloysite tubes, one or more metal salts, one or more amines, and one or more of a citrate, a hydroxide and urea, to form a mixture; and forming the mixture into a composite.

The present disclosure also relates to a composite material, such as for an electrochemical storage device. The composite material includes an amount of halloysite tubes having one or more oxides, one or more hydroxides, or both, on at least a surface of the halloysite tubes.

The present disclosure also relates to an electrode. The electrode includes a composite material including an amount of halloysite tubes having one or more oxides, one or more hydroxides, or both, on at least a surface of the halloysite tubes; a conductive agent; and a binder.

The present disclosure also relates to an electrochemical storage device. The electrochemical storage device includes a working electrode including a composite material that includes an amount of halloysite tubes having one or more oxides, one or more hydroxides, or both, on at least a surface of the halloysite tubes, a conductive agent, and a binder; a counter electrode; a reference electrode; and an electrolyte in contact with the working electrode, the reference electrode and the counter electrode.

The present disclosure also relates to a method of making an electrode. The method includes adding a conductive agent, a binder and a composite material to a solvent to form a mixture, the composite material including an amount of halloysite tubes having one or more oxides, one or more hydroxides, or both, on at least a surface of the halloysite tubes; and coating the mixture on a substrate.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. As will be used herein, X@Y denotes a composite having components X and Y. For example, a “NiCo-precursor halloysite” will mean “a composite of NiCo precursor and halloysite.”

FIG. 1A shows a scanning electron microscope (SEM) image of NiCo-precursor@halloysite.

FIG. 1B shows a transmission electron microscopy (TEM) image of NiCo-precursor@halloysite.

FIG. 1C shows an SEM image of NiCo₂O₂ nanosheets@halloysite tubes.

FIG. 1D shows a TEM image of NiCo₂O₂ nanosheets@halloysite tubes.

FIG. 1E shows a selected-area electron diffraction (SAED) pattern image of NiCo₂O₂ nanosheets@halloysite tubes.

FIG. 1F shows a high-resolution transmission electron microscopy (HRTEM) image of NiCo₂O₂ nanosheets@halloysite tubes.

FIG. 2 shows a thermogravimetric analysis (TGA) of halloysite tubes (I) and NiCo₂O₄-precursor@halloysite (II) under air flow with a temperature ramp of 10° C. min⁻¹.

FIG. 3 shows the X-Ray Diffraction (XRD) patterns of NiCo₂O₄ (I), NiCo₂O₄ nanosheets@halloysite tubes (II) and NiCo₂O₄ (III).

FIG. 4 shows the X-Ray photoelectron spectroscopy (XRS) spectra of NiCo₂O₄ nanosheets@HA tubes: (a) Full spectrum; (b) Co 2p; (c) Ni 2p; (d) O 1 s.

FIG. 5 shows the electrochemical characterizations of the NiCo₂O₄ nanosheets@halloysite tubes.

FIG. 5A shows cyclic voltammetry (CV) curves of the NiCo₂O₄ nanosheets@halloysite tubes at various scan rates ranging from 10 to 80 mV^{s-1}.

FIG. 5B shows the charge/discharge voltage profiles of the NiCo₂O₄ nanosheets@halloysite tubes at various current densities ranging from 6 to 30 A g⁻¹.

FIG. 5C shows the calculated capacitance of the NiCo₂O₄ nanosheets@halloysite tubes as a function of current density according to the data in FIG. 6B.

FIG. 5D shows the capacitance cycling performance of the NiCo₂O₄ nanosheets@halloysite tubes at current density of 10 A g⁻¹.

FIG. 6A shows an SEM image of halloysite tubes.

FIG. 6B shows a TEM image of halloysite tubes.

FIG. 6C shows an SEM image of α-Ni(OH)₂ nanosheets@halloysite tubes.

FIG. 6D shows a magnified SEM image of α-Ni(OH)₂ nanosheets@halloysite tubes.

FIG. 6E shows an TEM image of α-Ni(OH)₂ nanosheets@halloysite tubes.

FIG. 6F shows a magnified TEM image of α-Ni(OH)₂ nanosheets@halloysite tubes.

FIG. 7A shows an SEM image of NiO nanosheets@halloysite tubes composite after being treated at 300° C. in air.

FIG. 7B shows a magnified SEM image of NiO nanosheets@halloysite tubes composite after being treated at 300° C. in air.

FIG. 7C shows an TEM image of NiO nanosheets@halloysite tubes composite after being treated at 300° C. in air.

FIG. 7D shows a magnified TEM image of NiO nanosheets@halloysite tubes composite after being treated at 300° C. in air.

FIG. 7E shows an HRTEM image of NiO nanosheets@halloysite tubes composite.

FIG. 7F shows the SAED pattern of NiO nanosheets@halloysite tubes composite.

FIG. 8 shows the TGA of halloysite tubes (I), α-Ni(OH)₂ nanosheets@halloysite (II) and α-Ni(OH)₂ nanosheets (III) under air flow with a temperature ramp of 10° C. min⁻¹.

FIG. 9 shows the XRD patterns of halloysite tubes (I), α-Ni(OH)₂ nanosheets@halloysite tubes (II) and NiO nanosheets@halloysite tubes (II).

FIG. 10 shows the XPS survey spectrum of NiO nanosheets@halloysite tubes sample and (b) Ni 2p core level.

FIG. 11 shows the electrochemical characterizations of the NiO—NSs@halloysite tubes.

FIG. 11A shows the CV curves of the NiO—NSs@halloysite tubes at various scan rate ranging from 3 to 30 mV s⁻¹.

FIG. 11B shows the charge/discharge voltage profiles of the NiO—NSs@halloysite tubes at various current densities ranging from 5 to 50 A g⁻¹.

FIG. 11C shows the calculated capacitance of the NiO—NSs@halloysite tubes as a function of current density according to the data in FIG. 12B.

FIG. 11D shows the chronopotentiometry (CP) plots of the first fourteen cycles of the NiO—NSs@halloysite tubes at the current density of 10 A g⁻¹.

FIG. 11E shows the average specific capacitance retention of the NiO—NSs@halloysite tubes versus cycle number at a current density of 10 A g⁻¹.

FIG. 12A shows an SEM image of the ultrathin standing α-Ni(OH)₂ nanosheets@halloysite nanostructures.

FIG. 12B shows a magnified SEM image of the ultrathin standing α-Ni(OH)₂ nanosheets@halloysite nanostructures.

FIG. 12C shows a TEM image of the ultrathin standing α-Ni(OH)₂ nanosheets@halloysite nanostructures.

FIG. 12D shows a magnified TEM image of the ultrathin standing α-Ni(OH)₂ nanosheets@halloysite nanostructures.

FIG. 13 shows the TGA of halloysite tubes (I), α-Ni(OH)₂ nanosheets @HA (II) and α-Ni(OH)₂ nanosheets (III) under air flow with a temperature ramp of 10° C. min⁻¹.

FIG. 14 shows the Fourier transform infrared (FTIR) spectra of pure halloysite tubes and α-Ni(OH)₂ nanosheets@halloysite.

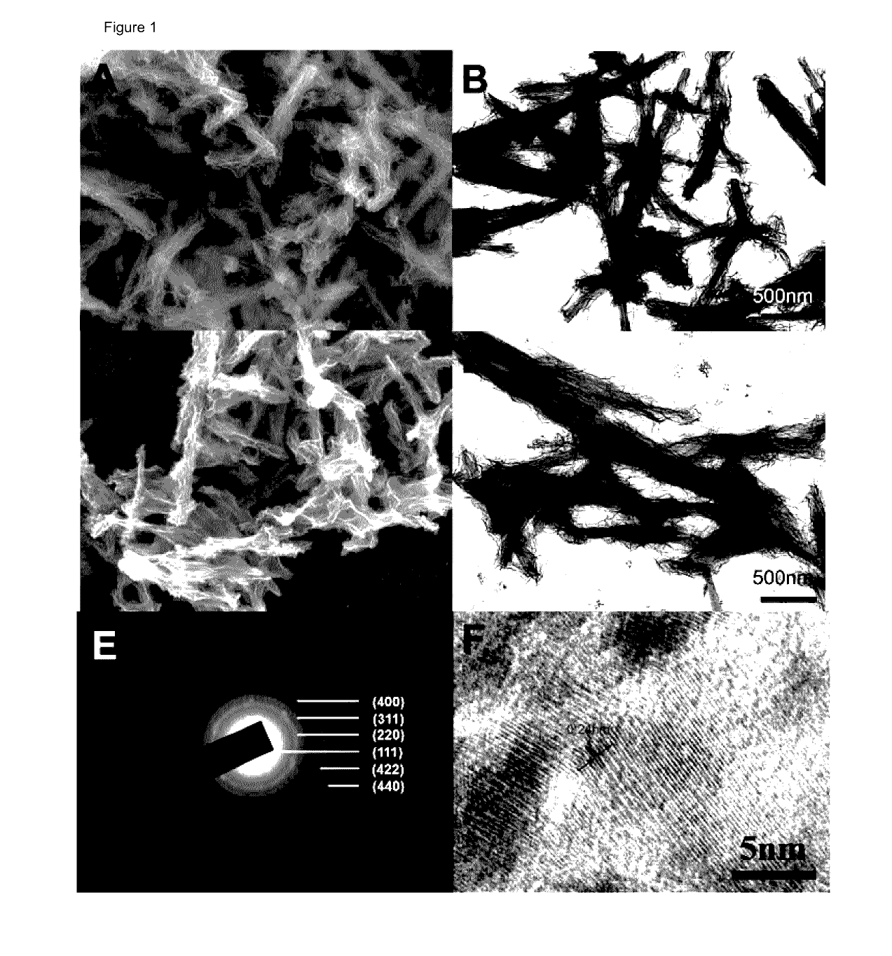

FIG. 1 SA shows the XPS survey spectrum of α-Ni(OH)₂@halloysite sample.

FIG. 15B shows the XPS survey spectrum of Ni 2p core level.

FIG. 16 shows the electrochemical characterizations of the α-Ni(OH)₂ nanosheets@halloysite.

FIG. 16A shows CV curves α-Ni(OH)₂ nanosheets@halloysite at various scan rate ranging from 3 to 80 mV s⁻¹.

FIG. 16B shows the charge/discharge voltage profiles α-Ni(OH)₂ nanosheets@halloysite at various current densities ranging from 5 to 30 A g⁻¹.

FIG. 16C shows the calculated capacitance α-Ni(OH)₂ nanosheets@halloysite as a function of current density according to the data in FIG. 16B.

FIG. 16D shows the capacitance cycling performance at current density of 10 A g⁻¹ of α-Ni(OH)₂ nanosheets @halloysite (I), α-Ni(OH)₂ (II) and halloysite tubes (II).

FIG. 17A shows an SEM image of an aggregate of α-Ni(OH)₂ prepared without HA support.

FIG. 17B shows a TEM image of an aggregate of α-Ni(OH)₂ prepared without HA support.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

Halloysite (HA), a type of one-dimensional tubular clay mineral, has versatile features, such as high porosity, tunable surface chemistry and low cost. It is a hydrous silicate material with a lamellar structure, which belongs to a monoclinic system. Halloysite possesses excellent cation/anion exchange capacity, OH⁻ groups and exhibit hydrophilic performance. Accordingly, when the halloysite forms a composite with an oxide or a hydroxide, the halloysite provides abundant OH⁻ groups to accelerate reversible conversions between divalent and trivalent metal ions (M²⁺/M³⁺). Such a synergy results in an increased electron conduction speed and therefore greatly increases high-rate energy storage capacity. The special cavity structure, porous structure, and lamellar structure of the halloysite tubes can provide more sites for assembly of oxides and/or hydroxides on at least a surface of the halloysite tubes, which increases high-rate energy storage capacity by increasing the number of available channels for ion conduction.

A method of preparing a composite is disclosed. The method includes contacting an amount of halloysite tubes, one or more metal salts, one or more amines, and one or more of a citrate, a hydroxide and urea, to form a mixture, and forming the mixture into a composite. In some embodiments, the one or more amines include hexamethylenetetramine, tetraethylenepentamine, triethylenetetramine, diethylenetriamine, or a combination thereof. In some embodiments, the citrate includes sodium citrate, potassium citrate, lithium citrate, or a combination thereof. In some embodiments, the hydroxide includes ammonium hydroxide.

In some embodiments, the method further includes sonicating the amount of halloysite tubes in a solvent before the contacting step. In some embodiments, the solvent is water, acetone, tetrahydrofuran (THF), dimethyl sulfoxide (DMSO), ethanol, methanol, isopropanol, or a combination thereof. The amount of solvent can be dependent on the amount of halloysite tubes to be sonicated, and may be about 30 mL to about 200 mL, for example, about 30 mL, about 40 mL, about 50 mL, about 60 mL, about 70 mL, about 80 mL, about 90 mL, about 100 mL, about 110 mL, about 120 mL, about 130 mL, about 140 mL, about 150 mL, about 160 mL, about 170 mL, about 180 mL, about 190 mL, about 200 mL, or an amount between any of these values. In some embodiments, the amount of halloysite tubes present in the solvent is about 0.125 mg/mL to about 10 mg/mL, for example, about 0.125 mg/mL, about 1 mg/mL, about 2 mg/mL, about 3 mg/mL, about 4 mg/mL, about 5 mg/mL, about 6 mg/mL, about 7 mg/mL, about 8 mg/mL, about 9 mg/mL, about 10 mg/mL, or an amount between any of these values. In some embodiments, sonicating the amount of halloysite tubes includes sonicating for about 1 minute to about 20 minutes. The sonication may be carried out for about 1 minute, about 2 minutes, about 3 minutes, about 4 minutes, about 5 minutes, about 6 minutes, about 7 minutes, about 8 minutes, about 9 minutes, about 10 minutes, about 11 minutes, about 12 minutes, about 13 minutes, about 14 minutes, about 15 minutes, about 16 minutes, about 17 minutes, about 18 minutes, about 19 minutes, about 20 minutes, or for a period of time between any of these values.

In some embodiments, the one or more metal salts may include metal nitrate, metal chloride, metal chlorate, metal sulfate, metal phosphate, or a combination thereof. In some embodiments, the one or more metal salts may include nitrate salt, sulfate salt, chlorate salt, chloride salt, phosphate salt, or a combination thereof. In some embodiments, the one or more metal salts may include a transition metal salt. In some embodiments, the one or more metal salts may include be scandium salt, titanium salt, vanadium salt, chromium salt, manganese salt, iron salt, cobalt salt, nickel salt, copper salt, zinc salt, indium salt, molybdenum salt, or a combination thereof. In some embodiments, the one or more metal salts are present in the mixture at a concentration of about 1 mM to about 1000 mM. In some embodiments, the one or more metal salts are present in the mixture at a concentration of about 1 mM to about 100 mM, about 100 mM to about 500 mM, or about 500 mM to about 1000 mM. The metal salts may be present in the mixture at a concentration of about 1 mM, about 5 mM, about 10 mM, about 15 mM, about 20 mM, about 25 mM, about 30 mM, about 35 mM, about 40 mM, about 45 mM, about 50 mM, about 55 mM, about 60 mM, about 65 mM, about 70 mM, about 75 mM, about 80 mM, about 85 mM, about 90 mM, about 95 mM, about 100 mM, about 105 mM, about 110 mM, about 115 mM, about 120 mM, about 125 mM, about 130 mM, about 135 mM, about 140 mM, about 145 mM, about 150 mM, about 155 mM, about 160 mM, about 165 mM, about 170 mM, about 175 mM, about 180 mM, about 185 mM, about 190 mM, about 195 mM, about 200 mM, about 205 mM, about 210 mM, about 215 mM, about 220 mM, about 225 mM, about 230 mM, about 235 mM, about 240 mM, about 245 mM, about 250 mM, about 255 mM, about 260 mM, about 265 mM, about 270 mM, about 275 mM, about 280 mM, about 285 mM, about 290 mM, about 295 mM, about 300 mM, about 305 mM, about 310 mM, about 315 mM, about 320 mM, about 325 mM, about 330 mM, about 335 mM, about 340 mM, about 345 mM, about 350 mM, about 355 mM, about 360 mM, about 365 mM, about 370 mM, about 375 mM, about 380 mM, about 385 mM, about 390 mM, about 395 mM, about 400 mM, about 405 mM, about 410 mM, about 415 mM, about 420 mM, about 425 mM, about 430 mM, about 435 mM, about 440 mM, about 445 mM, about 450 mM, about 455 mM, about 460 mM, about 465 mM, about 470 mM, about 475 mM, about 480 mM, about 485 mM, about 490 mM, about 495 mM, about 500 mM, about 505 mM, about 510 mM, about 515 mM, about 520 mM, about 525 mM, about 530 mM, about 535 mM, about 540 mM, about 545 mM, about 550 mM, about 555 mM, about 560 mM, about 565 mM, about 570 mM, about 575 mM, about 580 mM, about 585 mM, about 590 mM, about 595 mM, about 600 mM, about 605 mM, about 610 mM, about 615 mM, about 620 mM, about 625 mM, about 630 mM, about 635 mM, about 640 mM, about 645 mM, about 650 mM, about 655 mM, about 660 mM, about 665 mM, about 670 mM, about 675 mM, about 680 mM, about 685 mM, about 690 mM, about 695 mM, about 700 mM, about 705 mM, about 710 mM, about 715 mM, about 720 mM, about 725 mM, about 730 mM, about 735 mM, about 740 mM, about 745 mM, about 750 mM, about 755 mM, about 760 mM, about 765 mM, about 770 mM, about 775 mM, about 780 mM, about 785 mM, about 790 mM, about 795 mM, about 800 mM, about 805 mM, about 810 mM, about 815 mM, about 820 mM, about 825 mM, about 830 mM, about 835 mM, about 840 mM, about 845 mM, about 850 mM, about 855 mM, about 860 mM, about 865 mM, about 870 mM, about 875 mM, about 880 mM, about 885 mM, about 890 mM, about 895 mM, about 900 mM, about 105 mM, about 1110 mM, about 115 mM, about 120 mM, about 125 mM, about 130 mM, about 935 mM, about 940 mM, about 945 mM, about 950 mM, about 955 mM, about 960 mM, about 965 mM, about 970 mM, about 975 mM, about 980 mM, about 985 mM, about 990 mM, about 995 mM, about 1000 mM or a concentration between any of these values.

In some embodiments, the citrate is present in the mixture at a concentration of about 1 mM to about 1000 mM. In some embodiments, the citrate is present in the mixture at a concentration of about 1 mM to about 100 mM, about 100 mM to about 500 mM, or about 500 mM to about 1000 mM. The citrate may be present in the mixture at a concentration of about 1 mM, about 5 mM, about 10 mM, about 15 mM, about 20 mM, about 25 mM, about 30 mM, about 35 mM, about 40 mM, about 45 mM, about 50 mM, about 55 mM, about 60 mM, about 65 mM, about 70 mM, about 75 mM, about 80 mM, about 85 mM, about 90 mM, about 95 mM, about 100 mM, about 105 mM, about 110 mM, about 115 mM, about 120 mM, about 125 mM, about 130 mM, about 135 mM, about 140 mM, about 145 mM, about 150 mM, about 155 mM, about 160 mM, about 165 mM, about 170 mM, about 175 mM, about 180 mM, about 185 mM, about 190 mM, about 195 mM, about 200 mM, about 205 mM, about 210 mM, about 215 mM, about 220 mM, about 225 mM, about 230 mM, about 235 mM, about 240 mM, about 245 mM, about 250 mM, about 255 mM, about 260 mM, about 265 mM, about 270 mM, about 275 mM, about 280 mM, about 285 mM, about 290 mM, about 295 mM, about 300 mM, about 305 mM, about 310 mM, about 315 mM, about 320 mM, about 325 mM, about 330 mM, about 335 mM, about 340 mM, about 345 mM, about 350 mM, about 355 mM, about 360 mM, about 365 mM, about 370 mM, about 375 mM, about 380 mM, about 385 mM, about 390 mM, about 395 mM, about 400 mM, about 405 mM, about 410 mM, about 415 mM, about 420 mM, about 425 mM, about 430 mM, about 435 mM, about 440 mM, about 445 mM, about 450 mM, about 455 mM, about 460 mM, about 465 mM, about 470 mM, about 475 mM, about 480 mM, about 485 mM, about 490 mM, about 495 mM, about 500 mM, about 505 mM, about 510 mM, about 515 mM, about 520 mM, about 525 mM, about 530 mM, about 535 mM, about 540 mM, about 545 mM, about 550 mM, about 555 mM, about 560 mM, about 565 mM, about 570 mM, about 575 mM, about 580 mM, about 585 mM, about 590 mM, about 595 mM, about 600 mM, about 605 mM, about 610 mM, about 615 mM, about 620 mM, about 625 mM, about 630 mM, about 635 mM, about 640 mM, about 645 mM, about 650 mM, about 655 mM, about 660 mM, about 665 mM, about 670 mM, about 675 mM, about 680 mM, about 685 mM, about 690 mM, about 695 mM, about 700 mM, about 705 mM, about 710 mM, about 715 mM, about 720 mM, about 725 mM, about 730 mM, about 735 mM, about 740 mM, about 745 mM, about 750 mM, about 755 mM, about 760 mM, about 765 mM, about 770 mM, about 775 mM, about 780 mM, about 785 mM, about 790 mM, about 795 mM, about 800 mM, about 805 mM, about 810 mM, about 815 mM, about 820 mM, about 825 mM, about 830 mM, about 835 mM, about 840 mM, about 845 mM, about 850 mM, about 855 mM, about 860 mM, about 865 mM, about 870 mM, about 875 mM, about 880 mM, about 885 mM, about 890 mM, about 895 mM, about 900 mM, about 105 mM, about 1110 mM, about 115 mM, about 120 mM, about 125 mM, about 130 mM, about 935 mM, about 940 mM, about 945 mM, about 950 mM, about 955 mM, about 960 mM, about 965 mM, about 970 mM, about 975 mM, about 980 mM, about 985 mM, about 990 mM, about 995 mM, about 1000 mM or a concentration between any of these values. In some embodiments, the urea or the hydroxide is present in the mixture at a concentration of about 1 mM to about 1000 mM. In some embodiments, the urea or the hydroxide is present in the mixture at a concentration of about 1 mM to about 100 mM, about 100 mM to about 500 mM, or about 500 mM to about 1000 mM. The urea or the hydroxide may be present in the mixture at a concentration of about 1 mM, about 5 mM, about 10 mM, about 15 mM, about 20 mM, about 25 mM, about 30 mM, about 35 mM, about 40 mM, about 45 mM, about 50 mM, about 55 mM, about 60 mM, about 65 mM, about 70 mM, about 75 mM, about 80 mM, about 85 mM, about 90 mM, about 95 mM, about 100 mM, about 105 mM, about 110 mM, about 115 mM, about 120 mM, about 125 mM, about 130 mM, about 135 mM, about 140 mM, about 145 mM, about 150 mM, about 155 mM, about 160 mM, about 165 mM, about 170 mM, about 175 mM, about 180 mM, about 185 mM, about 190 mM, about 195 mM, about 200 mM, about 205 mM, about 210 mM, about 215 mM, about 220 mM, about 225 mM, about 230 mM, about 235 mM, about 240 mM, about 245 mM, about 250 mM, about 255 mM, about 260 mM, about 265 mM, about 270 mM, about 275 mM, about 280 mM, about 285 mM, about 290 mM, about 295 mM, about 300 mM, about 305 mM, about 310 mM, about 315 mM, about 320 mM, about 325 mM, about 330 mM, about 335 mM, about 340 mM, about 345 mM, about 350 mM, about 355 mM, about 360 mM, about 365 mM, about 370 mM, about 375 mM, about 380 mM, about 385 mM, about 390 mM, about 395 mM, about 400 mM, about 405 mM, about 410 mM, about 415 mM, about 420 mM, about 425 mM, about 430 mM, about 435 mM, about 440 mM, about 445 mM, about 450 mM, about 455 mM, about 460 mM, about 465 mM, about 470 mM, about 475 mM, about 480 mM, about 485 mM, about 490 mM, about 495 mM, about 500 mM, about 505 mM, about 510 mM, about 515 mM, about 520 mM, about 525 mM, about 530 mM, about 535 mM, about 540 mM, about 545 mM, about 550 mM, about 555 mM, about 560 mM, about 565 mM, about 570 mM, about 575 mM, about 580 mM, about 585 mM, about 590 mM, about 595 mM, about 600 mM, about 605 mM, about 610 mM, about 615 mM, about 620 mM, about 625 mM, about 630 mM, about 635 mM, about 640 mM, about 645 mM, about 650 mM, about 655 mM, about 660 mM, about 665 mM, about 670 mM, about 675 mM, about 680 mM, about 685 mM, about 690 mM, about 695 mM, about 700 mM, about 705 mM, about 710 mM, about 715 mM, about 720 mM, about 725 mM, about 730 mM, about 735 mM, about 740 mM, about 745 mM, about 750 mM, about 755 mM, about 760 mM, about 765 mM, about 770 mM, about 775 mM, about 780 mM, about 785 mM, about 790 mM, about 795 mM, about 800 mM, about 805 mM, about 810 mM, about 815 mM, about 820 mM, about 825 mM, about 830 mM, about 835 mM, about 840 mM, about 845 mM, about 850 mM, about 855 mM, about 860 mM, about 865 mM, about 870 mM, about 875 mM, about 880 mM, about 885 mM, about 890 mM, about 895 mM, about 900 mM, about 105 mM, about 1110 mM, about 115 mM, about 120 mM, about 125 mM, about 130 mM, about 935 mM, about 940 mM, about 945 mM, about 950 mM, about 955 mM, about 960 mM, about 965 mM, about 970 mM, about 975 mM, about 980 mM, about 985 mM, about 990 mM, about 995 mM, about 1000 mM or a concentration between any of these values. In some embodiments, the one or more amines are present in the mixture at a concentration of about 1 mM to about 1000 mM. In some embodiments, the one or more amines are present in the mixture at a concentration of about 1 mM to about 100 mM, about 100 mM to about 500 mM, or about 500 mM to about 1000 mM. The one or more amines may be present in the mixture at a concentration of about 1 mM, about 5 mM, about 10 mM, about 15 mM, about 20 mM, about 25 mM, about 30 mM, about 35 mM, about 40 mM, about 45 mM, about 50 mM, about 55 mM, about 60 mM, about 65 mM, about 70 mM, about 75 mM, about 80 mM, about 85 mM, about 90 mM, about 95 mM, about 100 mM, about 105 mM, about 110 mM, about 115 mM, about 120 mM, about 125 mM, about 130 mM, about 135 mM, about 140 mM, about 145 mM, about 150 mM, about 155 mM, about 160 mM, about 165 mM, about 170 mM, about 175 mM, about 180 mM, about 185 mM, about 190 mM, about 195 mM, about 200 mM, about 205 mM, about 210 mM, about 215 mM, about 220 mM, about 225 mM, about 230 mM, about 235 mM, about 240 mM, about 245 mM, about 250 mM, about 255 mM, about 260 mM, about 265 mM, about 270 mM, about 275 mM, about 280 mM, about 285 mM, about 290 mM, about 295 mM, about 300 mM, about 305 mM, about 310 mM, about 315 mM, about 320 mM, about 325 mM, about 330 mM, about 335 mM, about 340 mM, about 345 mM, about 350 mM, about 355 mM, about 360 mM, about 365 mM, about 370 mM, about 375 mM, about 380 mM, about 385 mM, about 390 mM, about 395 mM, about 400 mM, about 405 mM, about 410 mM, about 415 mM, about 420 mM, about 425 mM, about 430 mM, about 435 mM, about 440 mM, about 445 mM, about 450 mM, about 455 mM, about 460 mM, about 465 mM, about 470 mM, about 475 mM, about 480 mM, about 485 mM, about 490 mM, about 495 mM, about 500 mM, about 505 mM, about 510 mM, about 515 mM, about 520 mM, about 525 mM, about 530 mM, about 535 mM, about 540 mM, about 545 mM, about 550 mM, about 555 mM, about 560 mM, about 565 mM, about 570 mM, about 575 mM, about 580 mM, about 585 mM, about 590 mM, about 595 mM, about 600 mM, about 605 mM, about 610 mM, about 615 mM, about 620 mM, about 625 mM, about 630 mM, about 635 mM, about 640 mM, about 645 mM, about 650 mM, about 655 mM, about 660 mM, about 665 mM, about 670 mM, about 675 mM, about 680 mM, about 685 mM, about 690 mM, about 695 mM, about 700 mM, about 705 mM, about 710 mM, about 715 mM, about 720 mM, about 725 mM, about 730 mM, about 735 mM, about 740 mM, about 745 mM, about 750 mM, about 755 mM, about 760 mM, about 765 mM, about 770 mM, about 775 mM, about 780 mM, about 785 mM, about 790 mM, about 795 mM, about 800 mM, about 805 mM, about 810 mM, about 815 mM, about 820 mM, about 825 mM, about 830 mM, about 835 mM, about 840 mM, about 845 mM, about 850 mM, about 855 mM, about 860 mM, about 865 mM, about 870 mM, about 875 mM, about 880 mM, about 885 mM, about 890 mM, about 895 mM, about 900 mM, about 105 mM, about 1110 mM, about 115 mM, about 120 mM, about 125 mM, about 130 mM, about 935 mM, about 940 mM, about 945 mM, about 950 mM, about 955 mM, about 960 mM, about 965 mM, about 970 mM, about 975 mM, about 980 mM, about 985 mM, about 990 mM, about 995 mM, about 1000 mM or a concentration between any of these values.

In some embodiments, the contacting step includes stirring the mixture for about 5 minutes to about 300 minutes. In some embodiments, the contacting step includes stirring the mixture for about 5 minutes to about 30 minutes. The mixture may be stirred for about 5 minutes, about 10 minutes, about 15 minutes, about 20 minutes, about 25 minutes, or about 30 minutes, about 35 minutes, about 40 minutes, about 45 minutes, about 50 minutes, about 55 minutes, about 60 minutes, about 65 minutes, about 70 minutes, about 75 minutes, about 80 minutes, about 85 minutes, about 90 minutes, about 95 minutes, about 100 minutes, about 105 minutes, about 110 minutes, about 115 minutes, about 120 minutes, about 125 minutes, or about 130 minutes, about 135 minutes, about 140 minutes, about 145 minutes, about 150 minutes, about 155 minutes, about 160 minutes, about 165 minutes, about 170 minutes, about 175 minutes, about 180 minutes, about 185 minutes, about 190 minutes, about 195 minutes, about 200 minutes, about 205 minutes, about 210 minutes, about 215 minutes, about 220 minutes, about 225 minutes, about 230 minutes, about 235 minutes, about 240 minutes, about 245 minutes, about 250 minutes, about 255 minutes, about 260 minutes, about 265 minutes, about 270 minutes, about 275 minutes, about 280 minutes, about 285 minutes, about 290 minutes, about 295 minutes, about 300 minutes, or a time period between any of these values.

In some embodiments, forming the mixture into the composite includes subjecting the mixture to a temperature of about 60° C. to about 95° C. The temperature at which the mixture is subjected to may be about 60° C., about 65° C., about 70° C., about 75° C., about 80° C., about 85° C., about 90° C., about 95° C., or a temperature between any of these values. In some embodiments, forming the mixture into the composite includes maintaining the mixture at the temperature for about 1.5 hours to about 36 hours. In some embodiments, forming the mixture into the composite includes maintaining the mixture at the temperature for about 4 hours to about 12 hours. The temperature may be maintained for about 1.5 hours, about 2 hours, about 2.5 hours, about 3 hours, about 3.5 hours, about 4 hours, about 4.5 hours, about 5 hours, about 5.5 hours, about 6 hours, about 6.5 hours, about 7 hours, about 7.5 hours, about 8 hours, about 8.5 hours, about 9 hours, about 9.5 hours, about 10 hours, about 10.5 hours, about 11 hours, about 11.5 hours, or about 12 hours, about 12.5 hours, about 30 hours, about 13.5 hours, about 14 hours, about 14.5 hours, about 15 hours, about 15.5 hours, about 16 hours, about 16.5 hours, about 17 hours, about 17.5 hours, about 18 hours, about 18.5 hours, about 19 hours, about 19.5 hours, about 20 hours, about 20.5 hours, about 21 hours, about 21.5 hours, about 22 hours, about 22.5 hours, about 23 hours, about 23.5 hours, about 24 hours, about 24.5 hours, about 25 hours, about 25.5 hours, about 26 hours, about 26.5 hours, about 27 hours, about 27.5 hours, about 28 hours, about 28.5 hours, about 29 hours, about 29.5 hours, about 30 hours, about 30.5 hours, about 31 hours, about 31.5 hours, about 32 hours, about 32.5 hours, about 33 hours, about 33.5 hours, about 34 hours, about 34.5 hours, about 35 hours, about 35.5 hours, about 36 hours or a time period between any of these values.

In some embodiments, the method further includes drying the composite, heating the composite or both. In some embodiments, heating the composite includes calcinating at a temperature of about 300° C. to about 800° C. Calcinating may occur at a temperature of about 300° C., about 350° C., about 400° C., about 450° C., about 500° C., about 550° C., about 600° C., about 650° C., about 700° C., about 750° C. about 800° C., or a temperature between any of these values. In some embodiments, the heating is performed at a rate of about 0.5° C./min to about 20° C./min. Heating may be performed at a rate of about 0.5° C./min, about 1.0° C./min, about 1.5° C./min, about 2.0° C./min, about 2.5° C./min, about 3.0° C./min, about 3.5° C./min, about 4.0° C./min, about 4.5° C./min, about 5.0° C./min, about 5.5° C./min, about 6.0° C./min, about 6.5° C./min, about 7.0° C./min, about 7.5° C./min, about 8.0° C./min, about 8.5° C./min, about 9.0° C./min, about 9.5° C./min, about 10.0° C./min, about 10.5° C./min, about 11.0° C./min, about 11.5° C./min, about 12.0° C./min, about 12.5° C./min, about 13.0° C./min, about 13.5° C./min, about 14.0° C./min, about 14.5° C./min, about 15.0° C./min, about 15.5° C./min, about 16.0° C./min, about 16.5° C./min, about 17.0° C./min, about 17.5° C./min, about 18.0° C./min, about 18.5° C./min, about 19.0° C./min, about 19.5° C./min, about 20.0° C./min, or a rate between any of these values. In some embodiments, drying the composite includes drying at room temperature.

A composite material, for example for an electrochemical storage device, is also disclosed. The composite material includes an amount of halloysite tubes having one or more oxides, one or more hydroxides, or both, on at least a surface of the halloysite tubes.

In some embodiments, the one or more oxides may include a binary metal oxide, a ternary metal oxide, or both. The one or more oxides may have a generic formula of MₓO_{y} or MₓN_{y}O_{z}, wherein M and N may each be Sc, Ti, V, Cr, Mn, Fe, Co, Ni, Cu, Zn, In or Mo, x and y may each be a positive number ranging from 1 to 3, and z may be a positive number ranging from 1 to 4. In some embodiments, the binary metal oxide is NiO, Co₃O₄, CoO, Fe₃O₄, Fe₂O₃, MnO, Mn₂O₃, ZnO, or a combination thereof. In some embodiments, the ternary metal oxide is NiCo₂O₄, ZnCo₂O₄, ZnMn₂O₄, FeCo₂O₄, or a combination thereof. In some embodiments, the one or more hydroxides may include a metal hydroxide. The metal hydroxide can have a generic formula of M(OH)_{z} or MₓN_{y}(OH)_{z}, wherein M and N may each be Sc, Ti, V, Cr, Mn, Fe, Co, Ni, Cu, Zn, In or Mo, x and y may each be a positive number ranging from 1 to 3, and z may be a positive number ranging from 1 to 4. In some embodiments, the metal hydroxide is scandium hydroxide, titanium hydroxide, vanadium hydroxide, chromium hydroxide, manganese hydroxide, iron hydroxide, cobalt hydroxide, nickel hydroxide, copper hydroxide, zinc hydroxide, indium hydroxide, molybdenum hydroxide, or a combination thereof.

In some embodiments, the composite material is formed into one or more cylindrical tubes. In some embodiments, the one or more cylindrical tubes have an average diameter of about 50 nm to about 150 nm. In some embodiments, the one or more cylindrical tubes have an average diameter of about 50 nm to about 75 nm, about 75 nm to about 100 nm, or about 100 nm to about 150 nm. For example, the one or more cylindrical tubes can have an average diameter of about 50 nm, about 60 nm, about 70 nm, about 80 nm, about 90 nm, about 100 nm, about 110 nm, about 120 nm, about 130 nm, about 140 nm, about 150 nm, or an average diameter between any of these values.

In some embodiments, the one or more cylindrical tubes have an average inner diameter of about 40 nm to about 60 nm. In some embodiments, the one or more cylindrical tubes has an average inner diameter of about 40 nm to about 40 nm to about 50 nm or about 50 nm to about 60 nm. For example, the one or more cylindrical tubes can have an average inner diameter of about 40 nm, about 50 nm, about 60 nm, or an average inner diameter between any of these values. In some embodiments, the one or more cylindrical tubes have an average length of about 0.5 to about 3.0 micrometers. The average length may be about 0.8 micrometer to about 1.0 micrometer, about 1.0 micrometer to about 1.2 micrometers, about 1.2 micrometers to about 1.5 micrometers, or about micrometers 1.5 to about 2.0 micrometers.

In some embodiments, the one or more cylindrical tubes are formed into one or more sheets. In some embodiments, the one or more sheets have a hierarchical structure. In some embodiments, the one or more sheets have an average diameter of about 200 nm to about 500 nm. In some embodiments, the one or more sheets have an average diameter of about 300 to about 350 nm, about 350 nm to about 400, or an average diameter between any of these values. For example, the one or more sheets can have an average diameter of about 300 nm, about 350 nm, about 400 nm, or an average diameter between any of these values. In some embodiments, a space exists between the one or more sheets. In some embodiments, the one or more sheets have a thickness of about 3 nm to about 6 nm. In some embodiments, the one or more sheets have a thickness of about 3 nm, about 3.5 nm, about 4 nm, about 4.5 nm, about 5 nm, about 5.5 nm, about 6 nm, or any thickness between these values. In some embodiments, at least two of the sheets are spaced apart at a distance of about 5 nm to about 35 nm. In some embodiments, the at least two of the sheets are spaced at a distance of about 5 nm to about 10 nm, about 10 nm to about 15 nm, about 15 nm to about 20 nm, about 20 nm to about 25 nm, or about 25 nm to about 30 nm. For example, the at least two of the sheets can be spaced at an average distance of about 5 nm, about 10 nm, about 15 nm, about 20 nm, about 25 nm, about 30 nm, about 35 nm, or a distance between any of these values.

In some embodiments, the composite material has a capacitance of about 1200 F g⁻¹ to about 1800 F g⁻¹. In some embodiments, the composite material has a capacitance of about 1500 F g⁻¹ to about 1700 F g⁻¹. For example, the composite material may have a capacitance of about 1200 F g⁻¹, about 1300 F g⁻¹, about 1400 F g⁻¹, about 1500 F g⁻¹, about 1600 F g⁻¹, about 1700 F g⁻¹, about 1800 F g⁻¹, or a capacitance between any of these values. In some embodiments, the composite material has a capacitance loss of not more than about 10% after about 1500 cycles of charging and discharging at a current density of 10 A g⁻¹. In some embodiments, the composite material has a capacitance of at least about 1352 F g⁻¹ after 7800 cycles of charging and discharging at a current density of 10 A g⁻¹. In some embodiments, the composite material has a capacitance of at least about 1728 F g⁻¹ after 8600 cycles of charging and discharging at a current density of 10 A g⁻¹.

An electrode is also disclosed. The electrode includes a composite material including an amount of halloysite tubes having one or more oxides, one or more hydroxides, or both, on at least a surface of the halloysite tubes; a conductive agent; and a binder.

In some embodiments, the one or more oxides include a binary metal oxide, a ternary metal oxide, or both. The one or more oxides may have a generic formula of MₓO_{y} or MₙN_{y}Oz, wherein M and N may each be Sc, Ti, V, Cr, Mn, Fe, Co, Ni, Cu, Zn, In or Mo, x and y may each be a positive number ranging from 1 to 3, and z may be a positive number ranging from 1 to 4. In some embodiments, the binary metal oxide may be NiO, Co₃O₄, CoO, Fe₃O₄, Fe₂O₃, MnO, Mn₂O₃, ZnO, or a combination thereof. In some embodiments, the ternary metal oxide is NiCo₂O₄, ZnCo₂O₄. ZnMn₂O₄, FeCo₂O₄, or a combination thereof. In some embodiments, the one or more hydroxides may include a metal hydroxide. The metal hydroxide can have a generic formula of M(OH)_{z} or MₓN_{y}(OH)_{z}, wherein M and N may each be Sc, Ti, V, Cr, Mn, Fe, Co, Ni, Cu, Zn, In or Mo, x and y may each be a positive number ranging from 1 to 3, and z may be a positive number ranging from 1 to 4. In some embodiments, the metal hydroxide is scandium hydroxide, titanium hydroxide, vanadium hydroxide, chromium hydroxide, manganese hydroxide, iron hydroxide, cobalt hydroxide, nickel hydroxide, copper hydroxide, zinc hydroxide, indium hydroxide, molybdenum hydroxide, or a combination thereof.

In some embodiments, the conductive agent is carbon black, super-P—Li, C-NERGYTM Super C65, or a combination thereof. In some embodiments, the binder is a polymer binder. In some embodiments, the polymer binder is polytetrafluoroethylene, polytetrafluoroethylene (PVDF), polyvinyl alcohol (PVA), polytetrafluoroethylene (PTFE), carboxy methyl cellulose (CMC), polypropylene (PP), or a combination thereof. In some embodiments, the composite has a thickness of about 3 nm to about 6 nm. The composite may have a thickness of about 3 nm, about 3.5 nm, about 4 nm, about 4.5 nm, about 5 nm, about 5.5 nm, about 6 nm, or a thickness between any of these values.

An electrochemical storage device is also disclosed. The electrochemical storage device includes a working electrode including a composite material including an amount of halloysite tubes having one or more oxides, one or more hydroxides, or both, on at least a surface of the halloysite tubes, a conductive agent, and a binder; a counter electrode; a reference electrode; and an electrolyte in contact with the working electrode, the reference electrode and the counter electrode.

In some embodiments, the one or more oxides include a binary metal oxide, a ternary metal oxide or both. The one or more oxides may have a generic formula of MₓO_{y} or MₓN_{y}Oz, wherein M and N may each be Sc, Ti, V, Cr, Mn, Fe, Co, Ni, Cu, Zn, In or Mo, x and y may each be a positive number ranging from 1 to 3, and z may be a positive number ranging from 1 to 4. In some embodiments, the binary metal oxide is NiO, Co₃O₄, CoO, Fe₃O₄, Fe₂O₃, MnO, Mn₂O₃, ZnO, or a combination thereof. In some embodiments, the ternary metal oxide is NiCo₂O₄. ZnCo₂O₄. ZnMn₂O₄. FeCo₂O₄, or a combination thereof. In some embodiments, the ternary metal oxide is NiCo₂O₄. In some embodiments, the one or more hydroxides may include a metal hydroxide. The metal hydroxide can have a generic formula of M(OH)_{z} or MₓN_{y}(OH)_{z}, wherein M and N may each be Sc, Ti, V, Cr, Mn, Fe, Co, Ni, Cu, Zn, In or Mo, x and y may each be a positive number ranging from 1 to 3, and z may be a positive number ranging from 1 to 4. In some embodiments, the metal hydroxide may be scandium hydroxide, titanium hydroxide, vanadium hydroxide, chromium hydroxide, manganese hydroxide, iron hydroxide, cobalt hydroxide, nickel hydroxide, copper hydroxide, zinc hydroxide, indium hydroxide, molybdenum hydroxide, or a combination thereof.

In some embodiments, the conductive agent is carbon black, super-P—Li, C-NERGYTM Super C65, or a combination thereof. In some embodiments, the binder is a polymer binder. In some embodiments, the polymer binder may be polyvinylidene difluoride, polyvinyl alcohol (PVA), polytetrafluoroethylene (PTFE), carboxy methyl cellulose (CMC), polypropylene (PP), or a combination thereof.

In some embodiments, the composite material has a thickness of about 3 nm to about 6 nm. The composite material may have a thickness of about 3 nm to about 6 nm. The composite may have a thickness of about 3 nm, about 3.5 nm, about 4 nm, about 4.5 nm, about 5 nm, about 5.5 nm, about 6 nm, or a thickness between any of these values. In some embodiments, the electrolyte is KOH, KCl, H₂SO₄, or a combination thereof. In some embodiments, the electrochemical storage device is a supercapacitor or a lithium ion battery.

In some embodiments, a method of making an electrode is also disclosed. The method includes adding a conductive agent, a binder, and a composite material to a solvent to form a mixture; and coating the slurry on a substrate. In some embodiments, the substrate is graphite, nickel or both. For example, the substrate may be graphite paper. In another example, the substrate may be nickel foam. The composite material contains an amount of halloysite tubes having one or more oxides, one or more hydroxides, or both, on at least a surface of the halloysite tubes. In some embodiments, the conductive agent, the binder and the composite material are present in the mixture in a ratio of about 2:1:7 to about 1:1:8 by weight.

In some embodiments, the one or more oxides include a binary metal oxide, a ternary metal oxide, or both. The one or more oxides may have a generic formula of MₓO_{y} or MₓN_{y}O_{z}, wherein M and N may each be Sc, Ti, V, Cr, Mn, Fe, Co, Ni, Cu, Zn, In or Mo, x and y may each be a positive number ranging from 1 to 3, and z may be a positive number ranging from 1 to 4. In some embodiments, the binary metal oxide is NiO, Co₃O₄, CoO, Fe₃O₄, Fe₂O₃, MnO, Mn₂O₃, ZnO, or a combination thereof. In some embodiments, the ternary metal oxide is NiCo₂O₄, ZnCo₂O₄, ZnMn₂O₄. FeCo₂O₄, or a combination thereof. In some embodiments, the one or more hydroxides include a metal hydroxide. The metal hydroxide can have a generic formula of M(OH)_{z} or MₓN_{y}(OH)_{z}, wherein M and N may each be Sc, Ti, V, Cr, Mn, Fe, Co, Ni, Cu, Zn, In or Mo, x and y may each be a positive number ranging from 1 to 3, and z may be a positive number ranging from 1 to 4. In some embodiments, the metal hydroxide is scandium hydroxide, titanium hydroxide, vanadium hydroxide, chromium hydroxide, manganese hydroxide, iron hydroxide, cobalt hydroxide, nickel hydroxide, copper hydroxide, zinc hydroxide, indium hydroxide, molybdenum hydroxide, or a combination thereof. In some embodiments, the conductive agent is carbon black, super-P—Li, C-NERGYTM Super C65, or a combination thereof. In some embodiments, the binder is a polymer binder. In some embodiments, the polymer binder may be polyvinylidene difluoride, polyvinyl alcohol (PVA), polytetrafluoroethylene (PTFE), carboxy methyl cellulose (CMC), polypropylene (PP), or a combination thereof. In some embodiments, the composite material has a thickness of 3 nm to about 6 nm. The composite may have a thickness of about 3 nm, about 3.5 nm, about 4 nm, about 4.5 nm, about 5 nm, about 5.5 nm, about 6 nm, or a thickness between any of these values.

### EXAMPLES

### Example 1

### Preparation of Halloysite@α-Ni(OH)₂ Composite Material

This example describes the preparation of halloysite@α-Ni(OH)₂ material and an analysis of a variety of its properties.

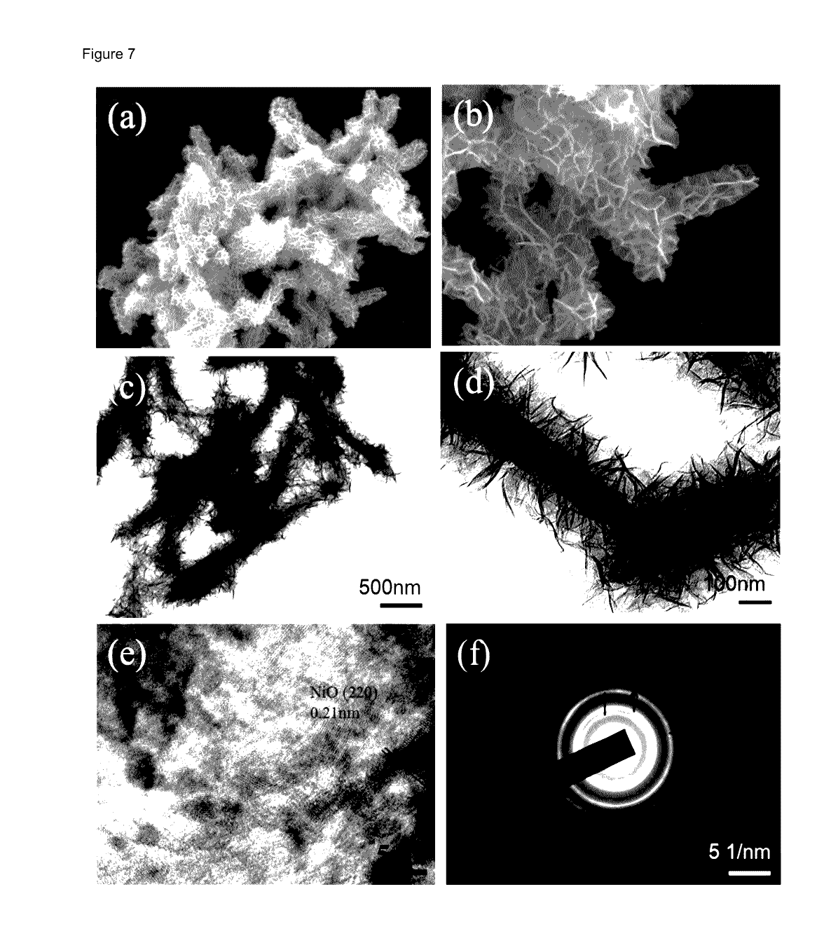

5 mg of halloysite tubes were weighed and added to 40 mL of water, followed by sonication for 5 minutes. 0.25 mM Ni(NO₃)₂.6H₂O, 0.25 mM hexamethylenetetramine, and 0.025 mM sodium citrate were added, stirred for 5 minutes, transferred into a round-bottom flask to form a light green solution. The solution was allowed to react in an oil bath at 90° C. for 6 hours. The resulting product was air dried in a room temperature environment. The light green product was collected by centrifugation. The α-Ni(OH)₂ nanosheets@halloysite hybrid nanostructures were obtained by washing with excess amounts of deionized water and ethanol and drying at 60° C. for 12 hours under vacuum. FIGS. 7C, 7D, 7E, and 7F show SEM and TEM images of α-Ni(OH)₂ nanosheets@halloysite tubes.

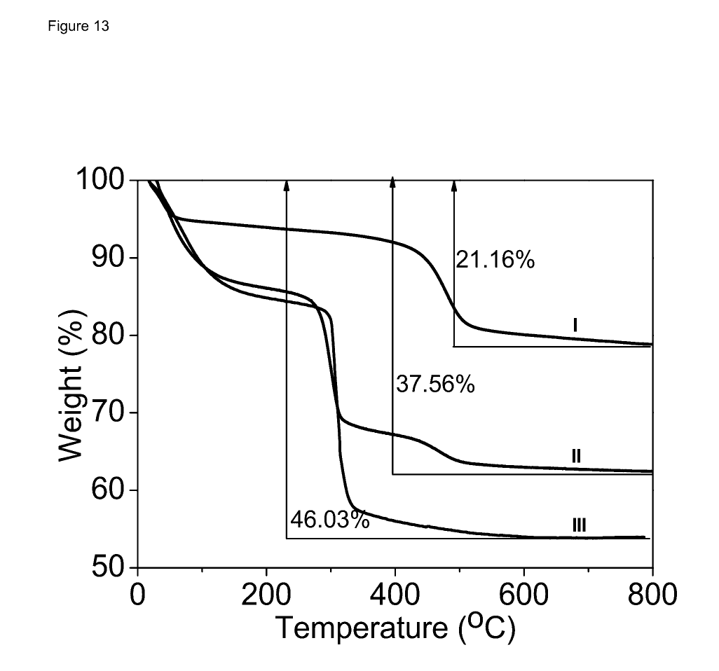

The mass content of the α-Ni(OH)₂ nanosheets in the hybrid structure was estimated by thermogravimetric analysis (TGA) (FIG. 13). Curve (I) showed that adsorbed water and interlayer water were removed in the first stage of this process (up to 60° C.), and that the thermal decomposition of halloysite was completed at 450° C. This weight loss, about 21.16%, was due to a continuous thermal depletion of deep-trapped hydroxyl groups and inherent moisture. Curve (III) indicates that while trapped moisture can be removed in the early stage of this process (up to 100° C.), the thermal decomposition of α-Ni(OH)₂ was completed at 300° C. The weight loss over 300° C. to 800° C. was assigned as a continuous thermal depletion of deep-trapped hydroxyl groups and removal of chemisorbed carbonate anions. The total weight loss of α-Ni(OH)₂ was about 46.03%. Curve (II) displayed the thermal decomposition of α-Ni(OH)₂@halloysite hybrid nanosheets and the weight loss was about 37.56%. From the three values of weight loss, the mass fraction of α-Ni(OH)₂ was estimated to be about 65.52% in the hybrid nanostructures.

X-ray diffraction (XRD) was used to further confirm the crystal structure and composition of the hybrid nanostructure. FIG. 18 showed the XRD patterns of halloysite, α-Ni(OH)₂@halloysite and α-Ni(OH)₂. Curve (a) revealed the main four characteristic diffraction peaks at 24.6°, 33.4°, 34.9° and 59.7° which correspond to the (006), (101), (012) and (110) of α-Ni(OH)₂, and was in agreement with standard power diffraction patterns of α-Ni(OH)₂ (JCPDS No. 38-0715). The diffraction peaks confirmed the high crystallinity of the as-prepared material. Additionally, Curve (c) showed crystal faces of halloysite tubes, such as (002), (110), (003), (211) at 24.84°, 35.02°, 37.98° and 54.34°, respectively. Curve (b) indicated that the hybrid materials synchronously possessed the characteristic diffraction peaks of halloysite and α-Ni(OH)₂, which confirmed the composition of the hybrid materials.

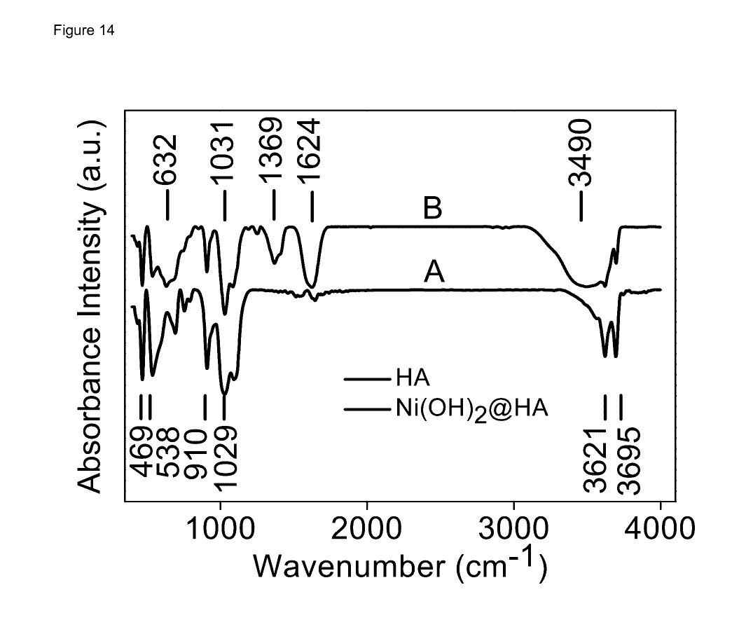

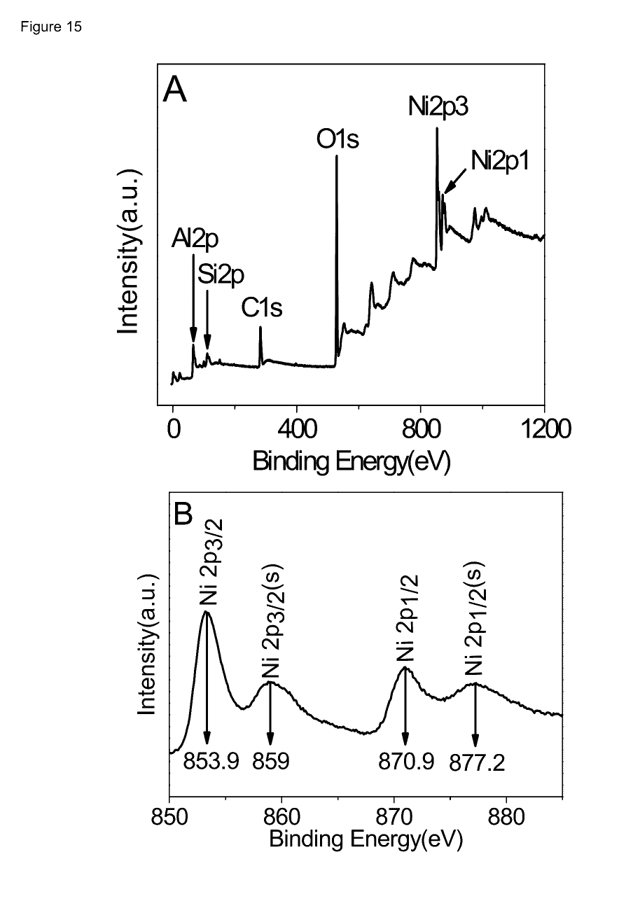

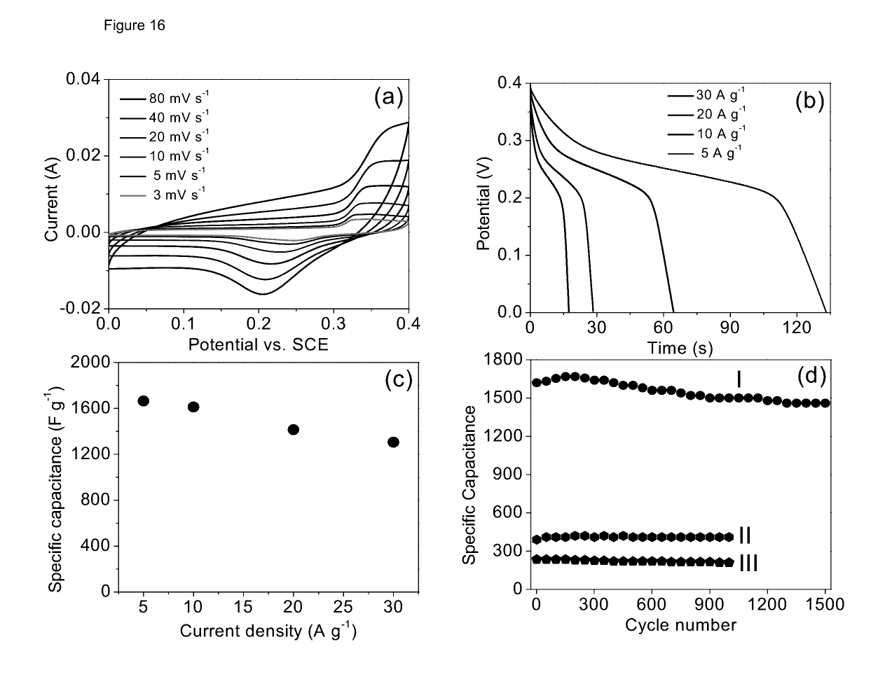

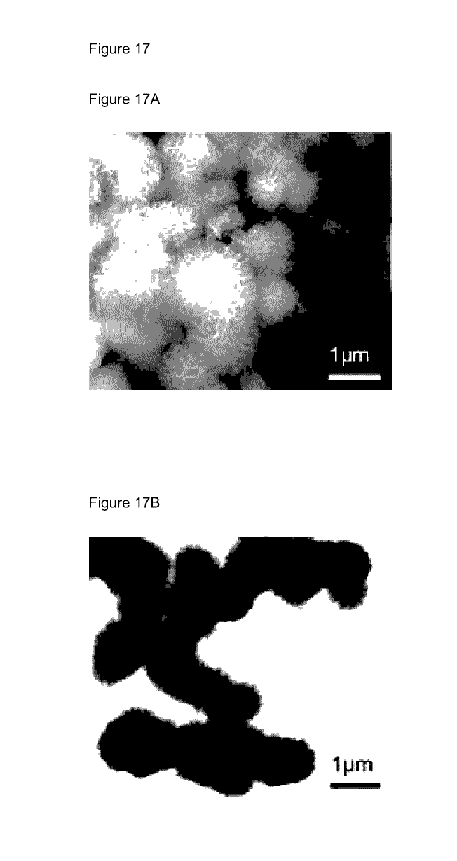

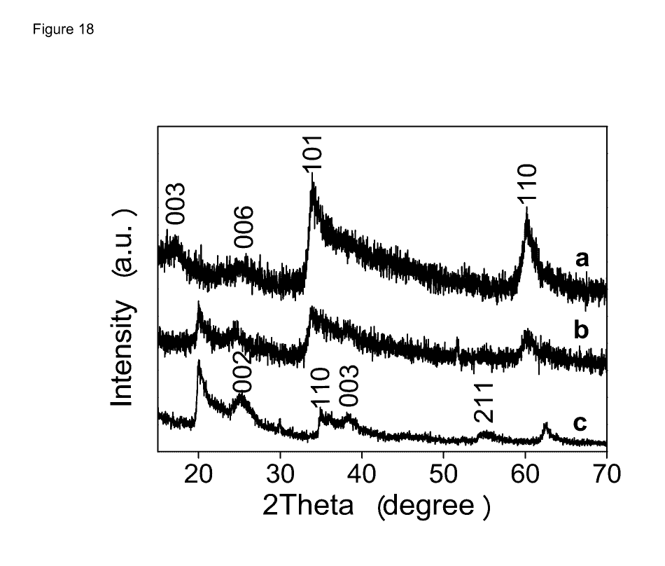

The chemical structures of as-prepared composites were further characterized by Fourier transform IR (FT-IR). Curve A in FIG. 14A showed the characteristic bands of halloysite, such as the stretching vibration of the inner-surface hydroxyl groups of Al(OH)₂ at 3695 and 3620 cm⁻¹, the deformation vibration of the above hydroxyl groups at 910 cm⁻¹, and the deformation vibration of Al—O—Si and Si—O—Si at 538 and 469 cm⁻¹. The reactions of the FT-IR spectra (FIG. 14, Curve B) indicated that the structure of halloysite tubes remained unaffected by the Ni(OH)₂-treatment, except the Si—O broad stretching band at about 1029 cm⁻¹, which shifted to 1031 cm⁻¹ for α-Ni(OH)₂@HA. The shifting of the Si—O broad stretching band indicated the formation of hydrogen bonding between the outer surface of the halloysite tubes and α-Ni(OH)₂. The new bands at 3490 and 1624 cm⁻¹ were most likely due to the stretching vibration and the corresponding deformation vibration of the hydroxyl groups involved in hydrogen bonding from absorbed H₂O and hydroxyl groups interacting with adsorbed species. Two strong bonds at 1369 and 632 cm⁻¹ were observed, which can be attributed to the vibration of the interbedded NO₃— groups of α-Ni(OH)₂ and Ni—O—H bending vibrations, respectively.

Further elemental composition and the oxidation state of the as-prepared composite were further investigated using X-ray photoelectron spectroscopy (XPS). The results were presented in FIG. 15. The survey spectrum (0-1200 eV) (FIG. 15A) of α-Ni(OH)₂@HA nanosheets showed mainly carbon (C 1 s), oxygen (O 1 s) and nickel species. The binding energies for Si 2p, Al 2p, O 1 s, and C 1 s were 104.4, 70.4, 529, and 282 eV, respectively. In the Ni 2p binding energies at 853.3 and 870.9 eV, corresponding to Ni 2p3/2 and Ni 2p1/2, respectively, with a spin-energy separation is of 104.4, 70.4, 529, and 282 eV, respectively. In the Ni 2p region (FIG. 15B), the spectrum showed two major peaks (FIG. 15B) with binding energies at 853.3 and 870.9 eV, corresponding to Ni 2p3/2 and Ni 2p1/2, respectively, with a spin-energy separation of 17.6 eV, which is characteristic of Ni(OH)₂ phase and was in agreement with the literature. In addition, the satellite peaks at around 859.0 eV and 877.4 eV were shake-up peaks of nickel at the high binding energy side of the Ni 2p3/2 and Ni 2p1/2 edge.

The CV curves of α-Ni(OH)₂@HA nanostructure electrode with various sweep rates ranging from 3 to 80 mV s⁻¹ were shown in FIG. 16A, which consisted of a pair of redox peaks within the potential range from 0 to 0.4 V (vs. SCE) revealed the pseudocapacitive characteristics as a result of the reversible reduction as described by reaction (1). Such a peak potential difference can be regarded as quasi-reversible. The shape of the CV curves were basically constant at different scan rates, which resulted from the improved mass transportation within the electrode material. FIG. 16B showed the galvanostatic discharge profiles at different current densities ranging from 3 to 30 A g⁻¹. The specific capacitance was calculated by the formula,

Cₘ=I×Δt/(ΔV×m) (2)

where Cₘ (F g⁻¹) was the specific capacitance, I was the discharge current, Δt was the discharge time, ΔV was the voltage range and m was the mass of the active material (for example, the total mass of the hybrid nanostructure). The calculated specific capacitance as a function of the discharge current density was plotted in FIG. 16C. It was seen that the specific capacitance was as high as 1305, 1415, 1620 and 1665 F g⁻¹ at discharge current densities of 30, 20, 10 and 5 A g⁻¹, respectively. In addition, the cycling stability was also evaluated by the repeated charging-discharging measurement at a constant current density of 10 A g⁻¹, as shown in FIG. 16D (I). The specific capacitance was around 1620 F g⁻¹ in the first cycle and it gradually decreased to 1460 F g⁻¹ after cycling for 1500 cycles. This corresponded to a capacitance loss of only 9.8%, which is considered a reasonably good performance for metal hydroxide nanostructures based electrode materials. Comparison of the cycling performances of α-Ni(OH)₂ aggregates and HA tubes were shown in FIG. 16D (II and III) and indicated that α-Ni(OH)₂@HA hybrid nanostructure possessed the miraculously high specific capacitance. The capacity was also higher than some Ni(OH)₂-based materials, which have a capacitance of 1212 and 813 F g⁻¹ at the corresponding discharge current densities of 2 and 16 A g⁻¹.

From the date above, the α-Ni(OH)₂@HA nanosheets hybrid nanostructures showed an enhanced electrochemical performance, which was ascribed to two main factors. First, the well-defined ultrathin standing and hierarchical nanosheets allowed the materials to be in constant contact with electrolyte. This shortened the pathways of ions and increased the availability of the nanostructure, ensuring good electrochemical performance of the supercapacitor. Second, the sufficient supply of hydroxyl groups and the remarkable cation/anion exchange capacity of HA increased the capacitance and stability of the supercapacitor from the chemical reaction kinetic point of view.

This example teaches that a new composite nanostructured material (α-Ni(OH)₂ nanosheets@halloysite) may improve the electrochemical performance of supercapacitors.

### Example 2

### Preparation of Halloysite@NiCo₂O₄ Composite Material

This example describes the preparation of halloysite@NiCo₂O₄ composite material and an analysis of a variety of its properties.

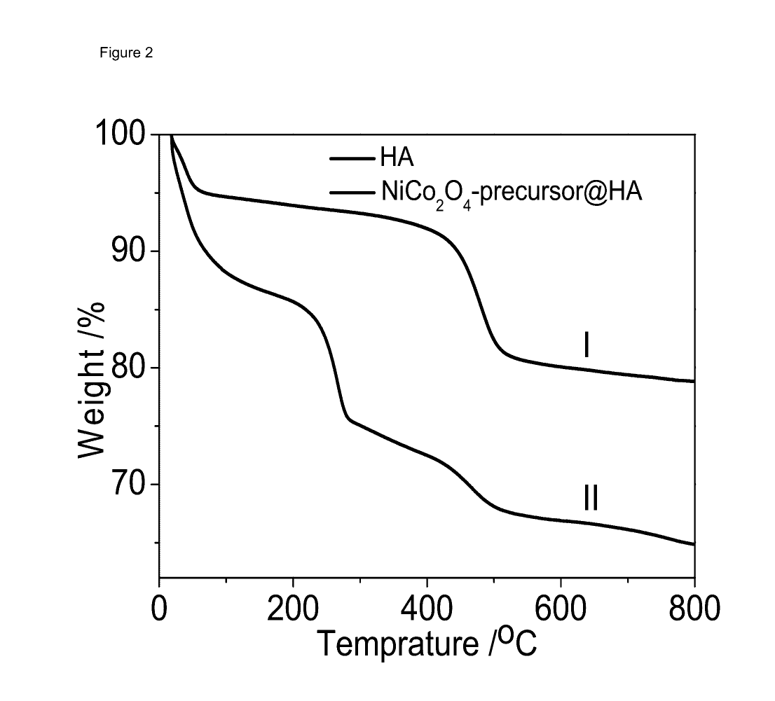

10 mg of halloysite tubes were weighed and added to 40 mL of water, followed by sonication for 5 minutes. 0.025 mM Ni(NO₃)₂.6H₂O, 0.05 mM Co(NO₃)₂.6H₂O, 0.25 mM hexamethylenetetramine, and 0.025 mM citric acid trisodium salt dehydrate were added, stirred for 5 minutes, and transferred to a round-bottom flask to form a light green solution. The solution was allowed to react in an oil bath at 90° C. for 6 hours with slow stirring. The resulting product was air dried in a room temperature environment. The product was collected by centrifugation and washed with deionized water and ethanol several times, and then dried at 60° C. for 12 hours under vacuum. The powder product was heated with a heating ramp of 1° C. min- to a temperature of 300° C. for 3.5 hours under atmospheric pressure. The resultant material was a halloysite NiCo₂O₄ composite. FIGS. 2D and 2E show SEM and TEM images of NiCo₂O₂ nanosheets@halloysite tube composites.

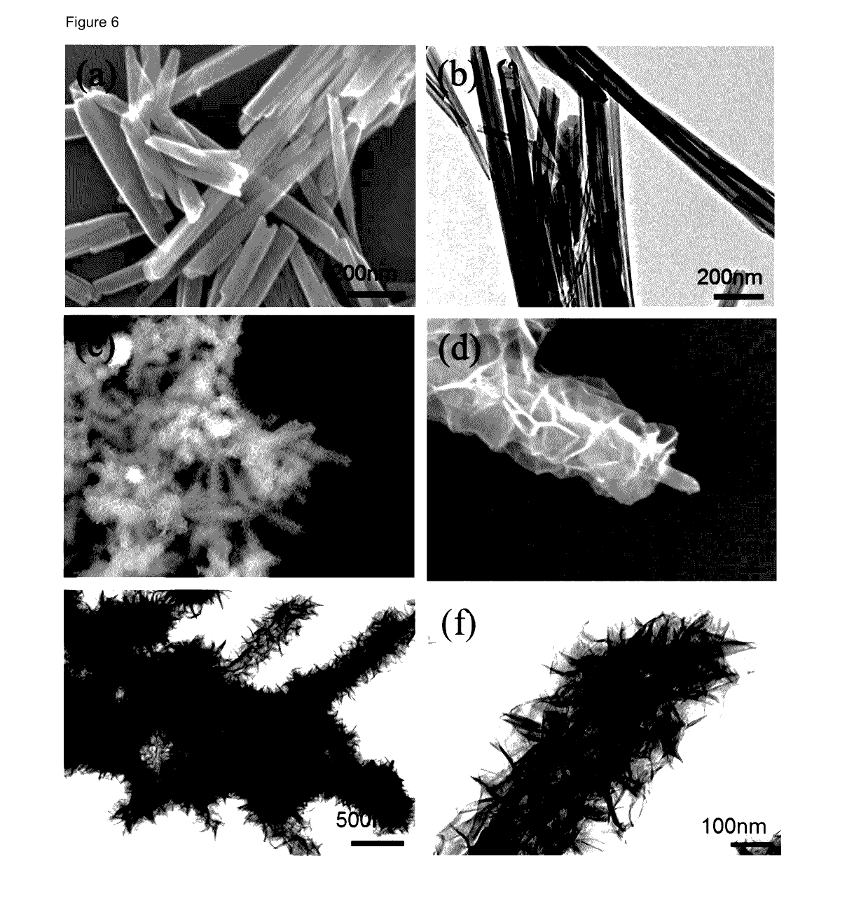

As shown in FIGS. 6A and 6B, the halloysite predominately consisted of cylindrical tubes 50-150 nm in diameter and 1-2 μm in length. The empty limen structure of HA was shown by TEM image. As shown in FIG. 6B, the average inner diameter of the HA was in the range of 40-60 nm. As seen in FIG. 1A, a large amount of uniform 1D nanostructures were obtained with hierarchical architectures. They were composed of uniform NiCo-precursor nanosheets, which were grown on the surface of HA tubes. FIG. 1B showed the corresponding TEM images of the NiCo-precursor nanosheets @HA. After annealing, the NiCo-precursor nanosheets were fully converted to crystallized NiCo₂O₄ nanosheets. SEM and TEM images of the NiCo₂O₄ nanosheets@HA (FIGS. 1C and 1D) showed that the ultrathin nanosheet morphology of the NiCo-precursor was well retained after the thermal conversion. The thickness was approximately 4 nm. The SAED pattern (FIG. 1E) indicated the polycrystalline nature of the NiCo₂O₄ nanosheets and was indexed to (200), (311), (400), (420) and (440) crystal planes of the NiCo₂O₄ phase. This was consistent with later XRD characterization. A representative high-resolution TEM image was shown in FIG. 1F. The measured interplanar distance was 0.24 nm, which matched well to the (311) plane of spinel NiCo₂O₄.

In order to understand the weight loss during the calcination process and to determine the calcining temperature of the sample, TGA data in air was obtained as shown in FIG. 2. Curve (I) showed the TGA curve of pure HA tubes, adsorbed water and interlayer water were removed in the first stage of this process (up to 60° C.). The thermal decomposition of HA was completed at 500° C. This weight loss was a continuous thermal depletion of deep-trapped hydroxyl groups and inherent moisture. Curve (II) displayed the thermal decomposition of NiCo₂O₄-precursor@HA hybrid nanostructures in air. The thermogram showed three stages of weight loss. The first weight loss stage (up to 100° C.) was attributed to the removal of chemisorbed and occluded water in the NiCo₂O₄-precursor HA sample during the heating process. The major weight loss that occurred between 250° C. and 300° C. could have been due to dehydration of the oxide hydrate. The final weight loss that occurred between 400° C.-500° C. could have been the thermal decomposition of HA.

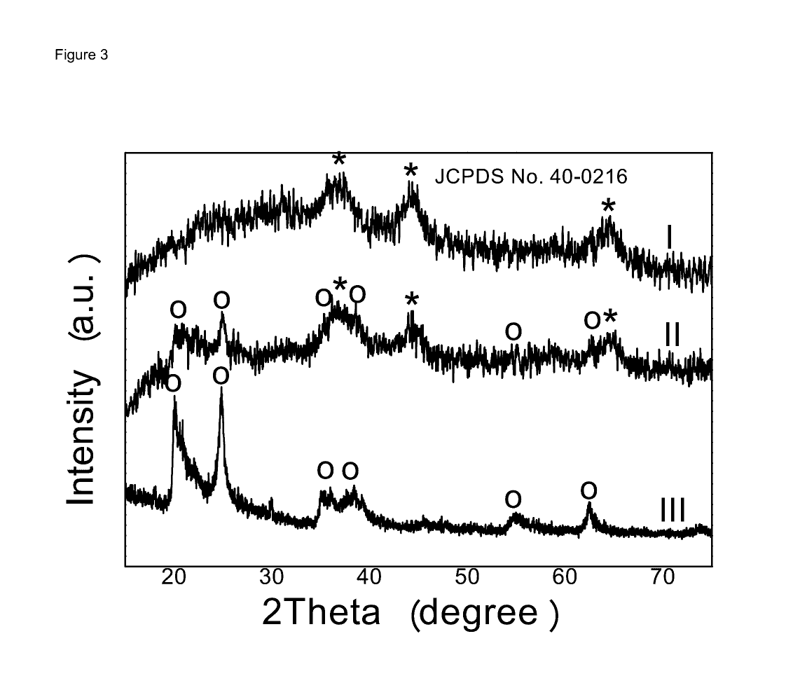

X-ray diffraction (XRD) was used to further confirm the crystal structure and composition of the hybrid structure. FIG. 3 showed the XRD patterns of NiCo₂O₄, NiCo₂O₄@HA and HA. Seven well-defined diffraction peaks (curve I) were observed at 20 values of 18.9°, 31.1°, 36.7°, 44.6°, 55.4°, 59.1° and 64.9°. All of these peaks, including their peak positions were successfully indexed to the (111), (220), (311), (400), (422), (511) and (440) plane reactions of the spinel NiCo₂O₄ crystal-line structure (JCPDF no. 20-0781). Additionally. Curve (III) showed crystal faces of halloysite tubes, such as (002), (110), (003), (211) at 24.84°, 35.02°, 37.98° and 54.34°, respectively. Curve (II) indicated that the hybrid materials synchronously possessed the characteristic diffraction peaks of HA and NiCo₂O₄, confirming the composition of the hybrid materials.

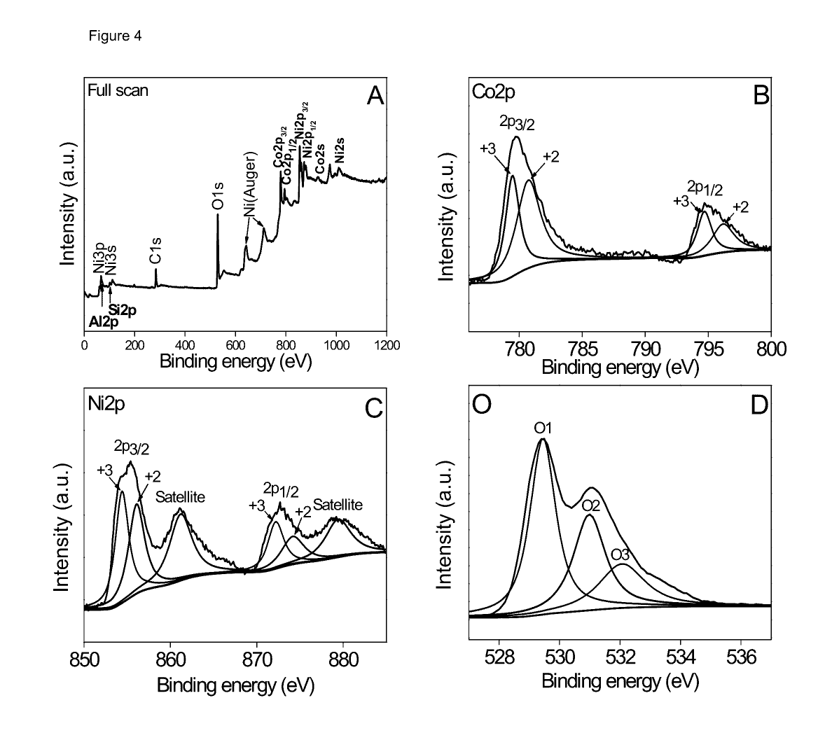

The more detailed elemental composition and the oxidation state of the as-prepared NiCo₂O₄ nanosheets@HA nanostructures were further characterized by XPS measurements. The corresponding results, presented in FIGS. 4A-4D. FIG. 4A, showed the survey XPS spectrum of the NiCo₂O₄ nanosheets@HA, mainly including carbon (C 1 s), oxygen (O 1 s), nickel and cobalt species. The halloysite tubes (HA) were primarily composed of Si, O, Al, C, and two Co species (Co²⁺ and Co³⁺). The binding energies at 779.3 eV and 794.3 eV were ascribed to Co³⁺. The binding energies for Si 2p, Al 2p, O 1 s, and C 1 s were 104.4, 70.4, 530, and 285 eV, respectively. In the Co2p spectra (FIG. 4B), another two fitting peaks at 781.0 eV and 795.7 eV were ascribed to Co²⁺. In the Ni2p spectra (FIG. 4C), two nickel species containing Ni²⁺ and Ni³⁺ were also observed. The fitting peaks at 854.0 eV and 871.7 eV were indexed to Ni²⁺, while the fitting peaks at 855.9 eV and 873.8 eV were indexed to Ni³⁺. The satellite peaks at around 861.0 eV and 879.4 eV were shake-up peaks of nickel at the high binding energy side of the Ni 2p3/2 and Ni 2p1/2 edge. The high resolution spectrum for O 1 s (FIG. 4D) showed three oxygen species marked as O 1, O 2 and O 3. According to previous reports, the fitting peak of O 1 at a binding energy at 529.6 eV was a typical metal-oxygen bond. O 2 at a binding energy of 531.1 eV is usually associated with oxygen in OH⁻ groups, indicating the presence of the NiCo₂O₄ material was hydroxylated to some extent as a result of either surface hydroxide or substitution of oxygen atoms at the surface by hydroxyl groups. O 3 at a binding energy of 532.5 eV could have been a mixed composition containing Co²⁺, Co³⁺, Ni²⁺ and Ni³⁺. Thus the formula of the proposed NiCo₂O₄ could be generally expressed as follows: Co²⁺₁₋ₓCo³⁺ₓ[Co³⁺Ni²⁺ₓNi³⁺₁₊ₓ]O₄ (0<x<1). The solid redox couple of Ni²⁺/Ni³⁺ and Co²⁺/Co³⁺ could afford enough active sites for methanol oxidation, which could have been one of the important factors contributing to the high electrocatalytic performance of NiCo₂O₄.

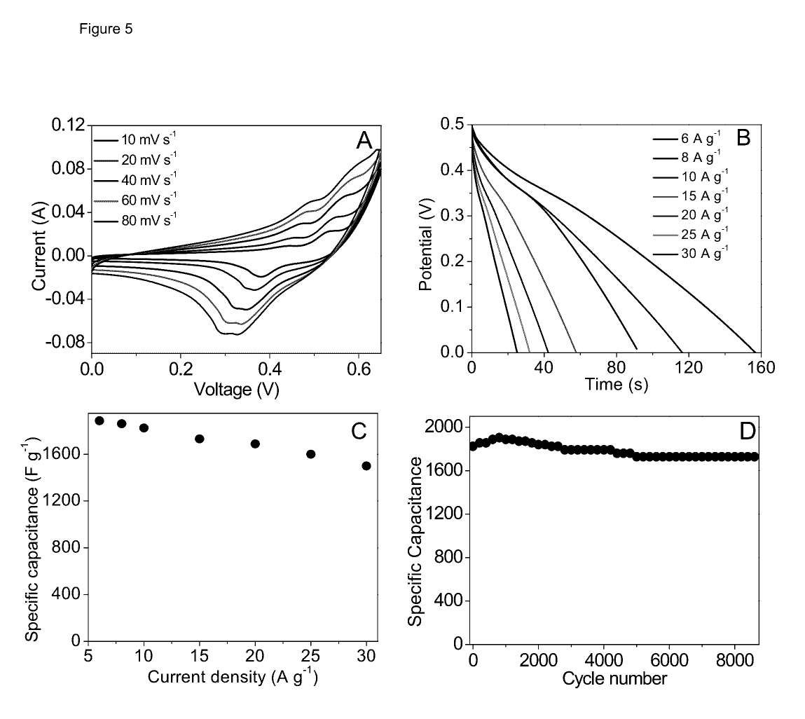

Cyclic voltammetry (CV) and chronopotentiometry (CP) were used to evaluate the electrochemical characteristics of the NiCo₂O₄ nanosheets@HA nanostructures and to characterize their electrochemical capacitance in a three-electrode cell. FIG. 5A presented the representative CV curves of the NiCo₂O₄ nanosheets@HA nanostructures electrode in 2 M KOH aqueous electrolyte at various scan rates ranging from 10 to 80 mV s⁻¹. Apparently, well defined redox reaction peaks within 0 to 0.65 V (vs. SCE) were visible in all CV curves, which indicated that the electrochemical capacitance of the NiCo₂O₄ nanosheets@HA nanostructures electrode was distinct from that of an electric double-layer capacitance with a common rectangular shape. These peaks mainly originated from Faradaic redox reactions related to MO/MOOH, where the M represents Ni and Co ions. Obviously, with the increasing scan rate, the shape of the CV curves basically remained unchanged except for the small shift of the peak position, thus indicating the excellent electrochemical reversibility and outstanding high-rate performance.

To further investigate the potential application of the NiCo₂O₄ nanosheets@HA in supercapacitors, galvanostatic charge-discharge measurements were carried out in 2 M KOH solution, between 0 and 0.5 V (vs. SCE) at various current densities which ranged from 6 to 30 A g⁻¹. The results were shown in FIG. 5B. The typical CP plots suggested desirable supercapacitive performance. The specific capacitance of the NiCo₂O₄ nanosheets@HA nanostructures was calculated from the CP curves in FIG. 5B, according to Eq. (3):

Cₘ=I×Δt/(ΔV×m) (3)

where C, I, t and ΔV were the specific capacitance (F g⁻¹) of NiCo₂O₄ nanosheets@HA electrode, the discharging current density (A g⁻¹), the discharging time (s) and the discharging potential range (V), respectively. The specific capacitance of the NiCo₂O₄ nanosheets@HA nanostructures at various current densities was calculated and plotted in FIG. 5D. The superstructure electrode delivered pseudo-capacitances of 1886.6, 1860.8, 1824, 1731, 1688, 1600 and 1500 F g⁻¹ at 6, 8, 10, 15, 20, 25 and 30 A g⁻¹, respectively. This suggested that ca. 80% of the capacitance was still retained when the charge-discharge rate changed from 6 to 30 A g⁻¹. Therefore, the electrode not only exhibited large specific capacitance but also maintained it well at higher current densities.

The good electrochemical performance resulted from unique structural features with numerous hierarchical, ultrathin nanosheets and fascinating synergetic properties with HA, which reduced the diffusion length for the electrolyte ions, offered rich accessible electroactive sites, and guaranteed enough electrolyte ions to rapidly contact the large surfaces of the electroactive NiCo₂O₄ nanosheets@HA nanostructure with good electronic conductivity. Ultrathin nanosheets also greatly enhanced the participation degree of NiCo₂O₄ nanosheets@HA in the charge-discharge process to obtain a desirable cycle life and high rate performance. HA tubes owning abundant OH ions could offer quick and sustainable supply or removal during the charge-discharge process and ensure that sufficient Faradaic reactions took place at high current densities for energy storage. Therefore, the unique NiCo₂O₄ nanosheets@HA electrode could result in high electrochemical utilization even at large current densities. The cycling performance of any electroactive material is one of the most significant parameters for its practical applications. The cycle life of NiCo₂O₄ nanosheets@HA nanostructures was carried out at a current density of 10 A g⁻¹. As demonstrated in FIG. 5D, the specific capacitance increased up to 1904 F g⁻¹ after the materials were fully activated through electrochemical reactions during charge-discharge. After cycling for 8600 cycles, the specific capacitance gradually decreased to 1728 F g⁻¹ and the capacitance loss was only 5.3%.

In addition, the capacitance of HA was 235 F g⁻¹ at the discharge current density of 10 A g⁻¹. Clearly, HA had low capacitance, but it could increase the participation degree of active materials, thereby enhancing the capacitance and stability.

This example teaches that NiCo₂O₄ nanosheets@halloysite nanostructures may be prepared by a facile method and that the electrochemical performance of the NiCo₂O₄ nanosheets@halloysite nanostructures could be an enhanced electrode material for supercapacitors.

### Example 3

### Preparation of NiO Nanosheets@Halloysite Composite Material

This present example describes the preparation of NiO nanosheets@halloysite composite material and an analysis of a variety of its properties.

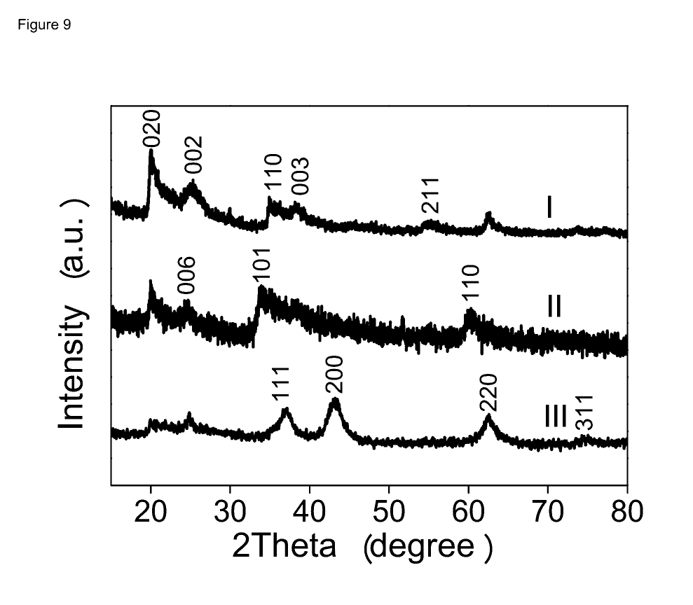

A commercial halloysite tube was selected as substrate for preparing the 1D Ni-precursor @HA hybrid nanostructures. Morphology and structure of HA tubes has been characterized with SEM and TEM. As shown in FIGS. 6A and 6B, the halloysite predominately consisted of cylindrical tubes with diameters of 50-150 nm and lengths of 1-2 μm. The empty limen structure of HA was revealed by TEM image. As shown in FIG. 6B, the average inner diameter of the HA was in the range of 40-60 nm. FIGS. 6C and 6D showed the SEM images of α-Ni(OH)₂ nanosheets@HA tubes, in which, a large amount of uniform 1D nanostructures with a hierarchical architecture could be clearly observed. In addition, the nanosheets had empty space among adjacent nanosheets. This feature could be beneficial to the penetration of the electrolyte, which could contribute to the improvement of electrochemical performance. FIGS. 6E and 6F showed the corresponding TEM image of the α-Ni(OH)₂ nanosheets@HA tubes hybrid nanostructures. α-Ni(OH)₂ nanosheets were grown uniformly on the surface of HA tubes to form a 1D structure. An enlarged view (FIG. 6E) provided evidence that the standing α-Ni(OH)₂ nanosheets were chemically grown on the HA tubes via a self-seeded growth process. Additionally, these nanosheets seemed to be ultrathin, which promoted more ions to participate in the reaction and increase the specific capacitance of the nanomaterial. All of the above indicates that the well-defined nanostructure of α-Ni(OH)₂ nanosheets@HA tubes could be prepared by this low-cost and effective solution route. The NiO—NSs@HA-NTs were obtained after calcination of the α-Ni(OH)₂ nanosheets@HA hybrid nanostructure composite at 300° C. for 3.5 hours. The microstructure and chemical composition of NiO—NSs@HA-NTs were investigated by SEM, TEM, HRTEM and SAED, with the results shown in FIG. 7. FIGS. 7A and 7B showed the SEM images of NiO—NSs@HA-NTs. The calcinated product was able to successfully 1 maintain the tubular, hierarchical, and ultrathin nanomorphology of the α-Ni(OH)₂ nanosheets@HA after the annealing conversion, which showed that the NiO nanosheets had excellent thermal stability. FIGS. 7C and 7D showed that nanosheets of NiO—NSs@HA-NTs were freely standing, which may have promoted penetration of the electrolyte and helped prevent aggregation of the active material. The diameters of the hierarchically structured NiO nanosheets@HA tubes were about 300-400 nm and the thickness of the NiO sheets was approximately 5 nm (FIG. 7E). The HRTEM image (FIG. 7E) taken from the NiO nanosheets showed inter-planar spacing of 0.21 nm, corresponding to the (200) facet of fac-centered cubic phase NiO. The selected-area electron diffraction (SAED) pattern (FIG. 7F) showed four intense rings indexed to the (111), (220), (222), (311) planes of NiO nanosheets. FIG. 9 showed the corresponding XRD patterns of: (I) the HA tubes; (II) α-Ni(OH)₂ nanosheets (HA tubes; and (III) NiO—NSs@HA-NTs. Curve (I) showed some crystal faces of halloysite tubes, such as (002), (110), (003), (211) at 24.84°, 35.02°, 37.98° and 54.34°, respectively. Curve (II) apparently revealed the main four characteristic diffraction peaks at 24.6°, 33.4°, 34.9° and 59.7° corresponding to the (006), (101), (012) and (110) of α-Ni(OH)₂, respectively, which was in agreement with standard power diffraction patterns of α-Ni(OH)₂ (JCPDS No. 38-0715). For curve (III), the diffraction peaks of NiO appeared at 37.19°, 43.23°, 62.81° and 75.33° matched well with the (111), (200), (220) and (311) planes of face-centered cubic NiO (JCPDS card no. 73-1523), respectively, which was consistent with the SAED results.

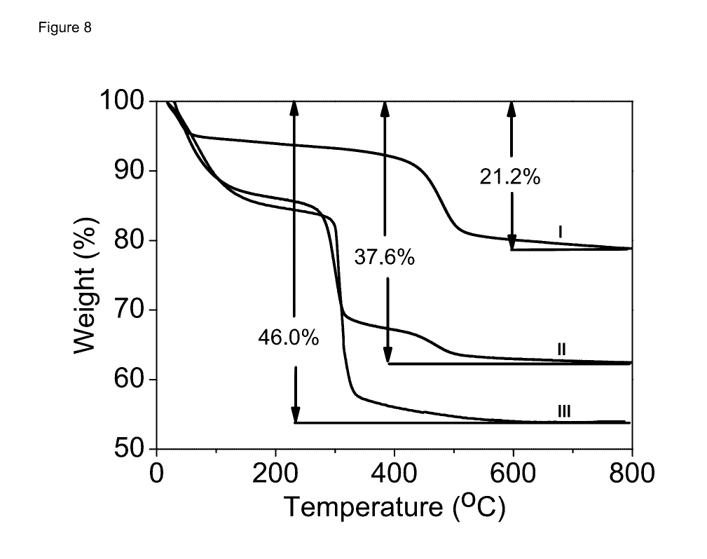

The thermal behavior of NiO—NSs@HA-NTs was studied by TGA, and the results were shown in FIG. 8. Curve (I) showed the TGA result of blank HA. The first stage of weight loss (around 60° C.) could have been assigned to the adsorbed water and interlayer water. The next stage of weight loss, which occurred at around 450° C., could be ascribed to a continuous thermal depletion of deep-trapped hydroxyl groups and inherent moisture. Curve (II) was the TGA result from α-Ni(OH)₂ nanosheets@HA nanohybrid. The early stage of weight loss (up to 100° C.) was due to the trapped moisture removal. The thermal decomposition of α-Ni(OH)₂ was intensively completed at 300° C. and corresponded to the second weight loss stage. The third stage of weight loss, which occurred from over 300° C. to 800° C., could have been assigned to a continuous thermal depletion of deep-trapped hydroxyl groups and the removal of chemisorbed carbonate anions. Note that the total weight loss was about 37.6%, which was much higher than that in pure HA (21.2%) and lower than that in α-Ni(OH)₂ (46.0% showed in curve III). From the three values of weight loss, the mass fraction of NiO was estimated to be about 43% in the hybrid nanostructures.

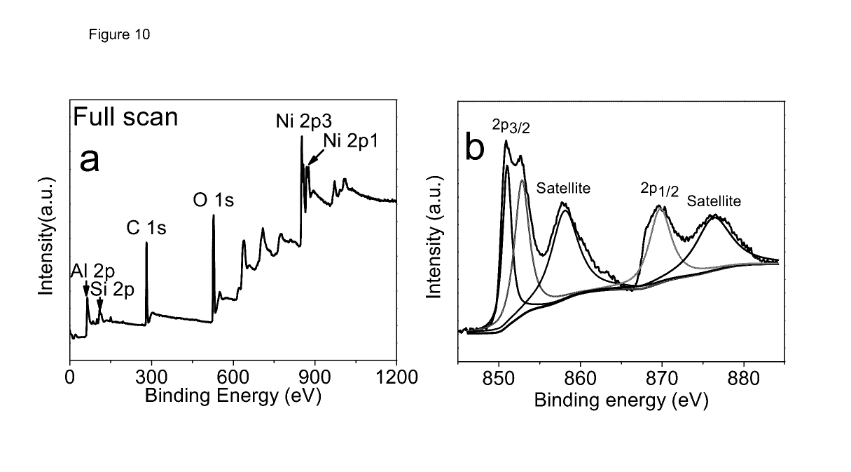

The more detailed elemental composition and the oxidation state of the as-prepared NiO—NSs@HA-NTs were further characterized by XPS measurements. The corresponding results, presented in FIG. 10A and FIG. 10B. FIG. 5A, showed the survey XPS spectrum exhibiting carbon (C 1 s), oxygen (O 1 s), nickel, silicon, and aluminum species. This reconfirmed that the prepared nanocomposite was composed of HA and NiO. In the Ni2p spectra (FIG. 5B), two major peaks with binding energies at 853.3 and 870.9 eV could be observed. This indicated two of nickel species: Ni²⁺ and Ni³⁺, respectively. These peaks matched well with previously reported data regarding shake-up peaks (861.0 eV and 879.4 eV) of nickel at the high binding energy side of the Ni 2p3/2 and Ni 2p1/2 edge.

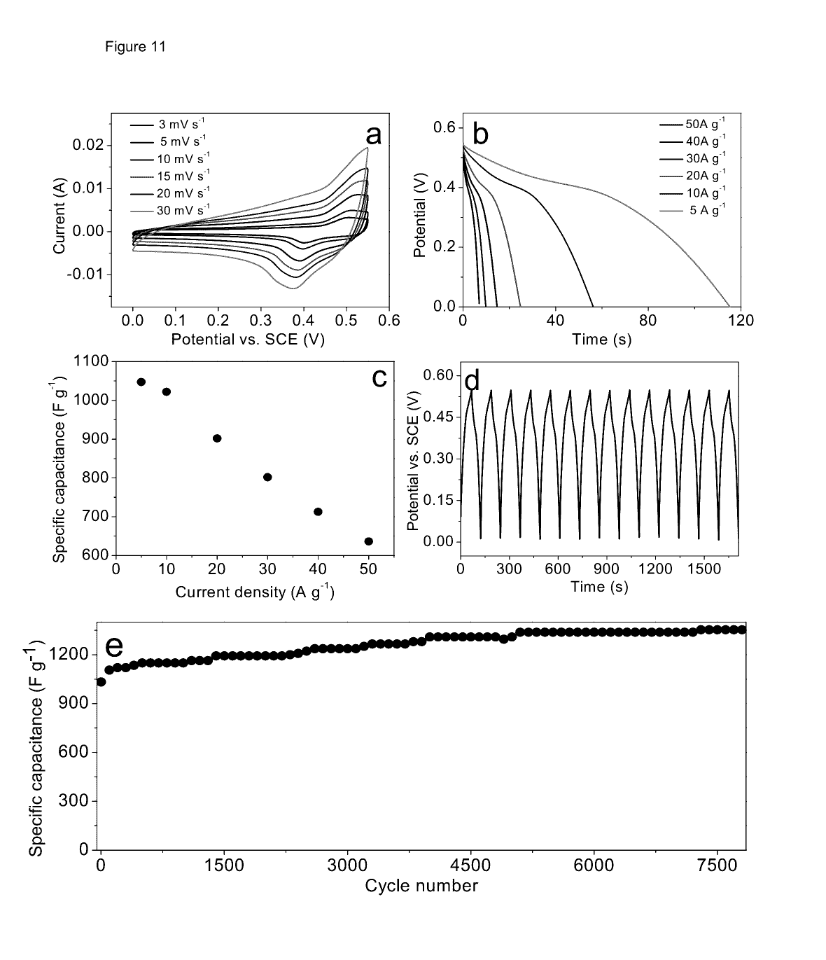

Cyclic voltammetry (CV) and chronopotentiometry (CP) were used to evaluate the electrochemical characteristics of the NiO—NSs@HA-NTs and to characterize their electrochemical capacitance in a three-electrode cell. FIG. 11A presented the representative CV curves of the NiO—NSs@HA-NTs electrode in a 2 M KOH electrolyte solution at various scan rates ranging from 3 to 30 mV s⁻¹. Well-defined redox reaction peaks within 0 to 0.55 V (vs. SCE) were visible in all CV curves, indicating that the electrochemical capacitance of the NiO—NSs@HA-NTs electrode was distinct from that of an electric double-layer capacitance with a common rectangular shape. These peaks mainly originated from Faradaic redox reactions related to MO/MOOH, where M represents Ni ions.

To further investigate the potential application of the NiO—NSs@HA-NTs in supercapacitors, galvanostatic charge-discharge measurements were carried out in 2 M KOH solution between 0 and 0.55 V (vs. SCE) at various current densities ranging from 5 to 50 A g⁻¹. As shown in FIG. 11B, the typical CP plots suggested the desirable supercapacitive performance. The specific capacitances of the NiO—NSs@HA-NTs tubes were calculated from the CP curves, according to Eq. (2):

Cₘ=I*Δt/(ΔV*m) (2)

where Cₘ (F g⁻¹) was the specific capacitance, I was the discharge current (A), Δt was the discharge time (s), ΔV was the potential window (V) and m was the mass of the active material (g) (i.e., the total mass of the hybrid nanostructure). The specific capacitance of the NiO—NSs@HA-NTs at various current densities was calculated and plotted in FIG. 11C. The unique superstructure electrode delivered good pseudocapacitances of ˜636.4, 712.7, 801.8, 901.8, 1021.8 and 1047.3 F g⁻¹ at 50, 40, 30, 20, 10 and 5 A g⁻¹, respectively. The excellent electrochemical performance resulted from the unique structure of the composite with numerous hierarchical, ultrathin and standing nanosheets and synergetic properties with HA. This unique architecture reduced the diffusion length for the electrolyte ions, offered rich accessible electroactive sites, and guaranteed enough electrolyte ions to rapidly contact the large surfaces of the electroactive NiO—NSs@HA-NTs. Ultrathin nanosheets also greatly enhanced the participation degree of NiO—NSs@HA-NTs in the charge-discharge process to obtain desirable cycle life and high rate performance. HA tubes owning abundant OH⁻ ions could offer quick and sustainable supply or removal of OH⁻ groups during the charge-discharge process and ensure that sufficient Faradaic reactions took place at high current densities for energy storage. Therefore, the NiO—NSs@HA-NTs electrode got high electrochemical utilization even at large current densities.

The cycling performance of electroactive material is one of the most significant parameters for the evaluation of practical applicability. The cycle lifespan of NiO—NSs@HA-NTs was carried out at a current density of 10 A g⁻¹. FIG. 11D showed the first fourteen cycles at the current density of 10 A g⁻¹. As demonstrated in FIG. 6E, the specific capacitance of NiO—NSs@HA-NTs increased after the materials were fully activated through electrochemical reactions during charge-discharge. After cycling for 7800 cycles, the specific capacitance gradually increased to 1352.7 F g⁻¹, which was much higher than the value of NiO nanosheets, NiO hollow spheres and NiO nanosheets tubes (588 F g⁻¹ at 3 A g⁻¹, 457 F g⁻¹ at 3 A g⁻¹ and 960 F g⁻¹ at 10 A g⁻¹, respectively). Although HA has low capacitance, its incorporation could increase the “insertion and de-insertion” rate of OH⁻ groups with active materials, and thereby enhanced the rate capability and stability.

This example teaches that the long cycling performance and rate capability of NiO—NSs@HA-NTs makes it a suitable as an electrode material because it meets the requirements of a practical energy storage device.

### Example 4

### Preparation of Halloysite@α-Ni(OH)₂ Composite Material

This present example describes the preparation of halloysite@α-Ni(OH)₂ composite material.

Commercial halloysite tubes were used to prepare the composite in accordance with the techniques described in Example 1. As shown in FIGS. 6A and 6B, the halloysite predominately included cylindrical tubes that were about 50 nm in diameter and about 1 m in length. The empty limen structure of halloysite was revealed by TEM image. As shown in FIG. 6B, the average inner diameter of the halloysite was about 40 nm.

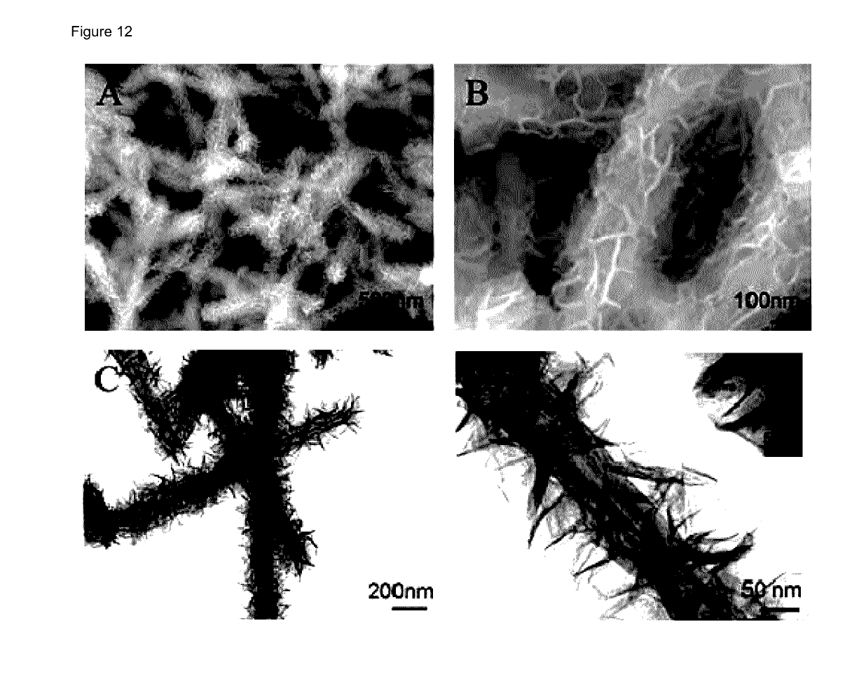

Aggregates of α-Ni(OH)₂ without halloysite support were prepared using a similar procedure. Such aggregates had the morphology shown in FIGS. 17A and 17B. It was apparent that α-Ni(OH)₂ aggregates possessed a chain morphology composed of irregular spheres with a diameter of 1 μm. The irregular spheres were composed of thin nanosheets. The morphology of α-Ni(OH)₂ nanosheets@halloysite were confirmed with SEM and TEM images (FIG. 12). As shown in FIG. 12A, a large amount of uniform 1D nanostructures were obtained with a hierarchical architecture. From an enlarged view of the FESEM image (FIG. 12B), these 1D nanostructures were composed of uniform α-Ni(OH)₂ nanosheets grown on the surface of halloysite tubes. In addition, the nanosheets showed a hierarchical array feature with empty space among adjacent nanosheets. This feature could benefit the penetration of an electrolyte, which could contribute to improved electrochemical performance. It was clearly observed in FIG. 12C that α-Ni(OH)₂ nanosheets could be grown rather uniformly and surrounded the halloysite tubes to form a 1D structure. As shown in the enlarged view FIG. 12D, standing α-Ni(OH)₂ nanosheets were chemically grown on the halloysite tubes, which may have been derived from the self-seeded growth process. The length of nanosheets was about 200 nm and the thickness was approximately 4 nm (the inset in FIG. 12D). The ultrathin nanosheets promoted more ions to participate in the reaction and increased the availability of the nanomaterials to enhance the energy density.

This example teaches that a variety of parameters may be used to prepare a halloysite@α-Ni(OH)₂ composite material.

### Example 5

### A Three Electrode Testing Device

This example describes a method of testing the electrochemical performance of the composite material.

A testing device with a three-electrode system was employed at room temperature, wherein platinum was used as the counter electrode, calomel was used as the reference electrode, and the working electrode included the prepared composite nanomaterial, a conductive agent (carbon black, Super-P—Li) and a polymer binder (polytetrafluoroethylene, PVDF); and 2M KOH solution was used as the electrolyte. The test was completed at room temperature. The capacity was controlled by regulating the thickness of enrichment layers and the size of sheets through adjusting the amounts of hexamethylenetetramine and sodium citrate.

This example teaches that an electrode, including the composite material, a conductive agent, and a binder, may be used to test the electrochemical performance of the composite material.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” and so on). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, and so on). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, and so on). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method to prepare a composite, the method comprising:
contacting an amount of halloysite tubes, one or more metal salts, one or more amines, and one or more of a citrate, a hydroxide and urea, to form a mixture; and
forming the mixture into a composite.

2. The method of claim 1, further comprising sonicating the amount of halloysite tubes in a solvent prior to contacting.

3. (canceled)

4. The method of claim 2, wherein sonicating the amount of halloysite tubes present in the solvent comprises sonicating about 0.125 mg/mL to about 10 mg/mL of halloysite tubes.

5. (canceled)

6. The method of claim 1, wherein contacting the one or more metal salts comprise contacting metal nitrate, metal chlorate, metal chloride, metal sulfate, metal phosphate, or a combination thereof.

7. (canceled)

8. The method of claim 1, wherein contacting the one or more metal salts comprises contacting a transition metal salt selected from a group consisting of scandium salt, titanium salt, vanadium salt, chromium salt, manganese salt, iron salt, cobalt salt, nickel salt, copper salt, zinc salt, indium salt, and molybdenum salt.

9. (canceled)

10. The method of claim 1, wherein contacting the one or more metal salts contacting at a concentration present in the mixture of about 1 mM to about 1000 mM.

11. The method of claim 1, wherein contacting the one or more amines comprises contacting hexamethylenetetramine, tetraethylenepentamine, triethylenetetramine, diethylenetriamine, or a combination thereof.

12. The method of claim 1, wherein contacting the citrate comprises contacting sodium citrate, potassium citrate, lithium citrate, or a combination thereof.

13. The method of claim 1, wherein contacting with the hydroxide comprises contacting with ammonium hydroxide.

14. The method of claim 1, wherein contacting with one or more of a citrate, a hydroxide and urea comprises contacting at a concentration present in the mixture of about 1 mM to about 1000 mM.

15.-17. (canceled)

18. The method of claim 1, wherein forming the mixture into the composite comprises subjecting the mixture to a temperature of about 60° C. to about 95° C.

15.-20. (canceled)

21. The method of claim 1, further comprising calcinating the composite at a temperature of about 300° C. to about 800° C.

22.-23. (canceled)

24. A composite material comprising an amount of halloysite tubes having one or more oxides, one or more hydroxides, or both, on at least a surface of the halloysite tubes.

25. The composite material of claim 24, wherein the one or more oxides comprise a binary metal oxide, a ternary metal oxide, or both.

26. The composite material of claim 25, wherein the binary metal oxide is NiO, Co₃O₄, CoO, Fe₃O₄, Fe₂O₃, MnO, Mn₂O₃, ZnO, or a combination thereof, and the ternary metal oxide is NiCo₂O₄, ZnCo₂O₄, ZnMn₂O₄, FeCo₂O₄, or a combination thereof.

27. (canceled)

28. The composite material of claim 24, wherein the one or more hydroxides comprise a metal hydroxide including scandium hydroxide, titanium hydroxide, vanadium hydroxide, chromium hydroxide, manganese hydroxide, iron hydroxide, cobalt hydroxide, nickel hydroxide, copper hydroxide, zinc hydroxide, indium hydroxide, molybdenum hydroxide, or a combination thereof.

29. (canceled)

30. The composite material of claim 24, wherein the composite material comprises one or more cylindrical tubes.

31.-39. (canceled)

40. The composite material of claim 24, wherein the composite material has a capacitance of about 1200 F g⁻¹ to about 1800 F g⁻¹.

41. (canceled)

42. The composite material of claim 24, wherein the composite material has a capacitance loss of not more than about 10% after about 1500 cycles of charging and discharging at a current density of 10 A g⁻¹.

43. The composite material of claim 24, wherein the composite material has a capacitance of at least about 1352 F g⁻¹ after 7800 cycles of charging and discharging at a current density of 10 A g⁻¹.

44. The composite material of claim 24, wherein the composite material has a capacitance of at least about 1728 F g⁻¹ after 8600 cycles of charging and discharging at a current density of 10 A g⁻¹.

45. An electrode comprising:
a composite material comprising an amount of halloysite tubes having one or more oxides, one or more hydroxides, or both, on at least a surface of the halloysite tubes;
a conductive agent; and
a binder.

46. The electrode of claim 45, wherein the one or more oxides comprise a binary metal oxide, a ternary metal oxide, or both.

47. The electrode of claim 46, wherein the binary metal oxide is NiO, Co₃O₄, CoO, Fe₃O₄, Fe₂O₃, MnO, Mn₂O₃, ZnO, or a combination thereof, and the ternary metal oxide is NiCo₂O₄, ZnCo₂O₄, ZnMn₂O₄, FeCo₂O₄, or a combination thereof.

48. (canceled)

49. The electrode of claim 45, wherein the one or more hydroxides comprise a metal hydroxide selected from a group consisting of scandium hydroxide, titanium hydroxide, vanadium hydroxide, chromium hydroxide, manganese hydroxide, iron hydroxide, cobalt hydroxide, nickel hydroxide, copper hydroxide, zinc hydroxide, indium hydroxide, and molybdenum hydroxide.

50. (canceled)

51. The electrode of claim 45, wherein the conductive agent comprises carbon black.

52. The electrode of claim 45, wherein the binder includes a polymer binder selected from a group consisting of polytetrafluoroethylene, PVDF, polyvinyl alcohol (PVA), polytetrafluoroethylene (PTFE), carboxy methyl cellulose (CMC), and polypropylene (PP).

53.-81. (canceled)
